(19) United States
(12) Patent Application Publication
(10) Pub. No.: US 2016/0260031 A1
(43) Pub. Date: Sep. 8, 2016

(54) SYSTEMS AND METHODS FOR DISTRIBUTING ACCESS RIGHTS

(71) Applicant: Tandum LLC, Nashville, TN (US)

(72) Inventors: Douglas A. Pace, Nashville, TN (US); Tyler M. Griffith, Nashville, TN (US); Jacques Woodcock, Nashville, TN (US)

(21) Appl. No.: 14/636,580

(22) Filed: Mar. 3, 2015

(51) Int. Cl. G06Q 10/02; G06Q 20/40; H04L 29/06

(52) U.S. Cl. CPC G06Q 10/02; H04L 63/101; G06Q 20/40

(57) ABSTRACT

Systems and methods for distributing access licenses or access rights are disclosed. Further disclosed are computer program products for enabling primary and secondary distributions of access rights and enabling assignment of identification tokens to access rights.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

The present invention relates generally to systems and methods for distributing one or more access rights or access licenses. More particularly, the present invention relates to distributing a primary distribution of one or more access rights for a venue, distributing a second distribution of one or more access rights for a venue, and assigning one or more identification tokens to one or more users in association with the primary and second distribution of access rights.

Further, provided herein, are systems and methods for distributing access rights and/or tickets to purchasers utilizing the issuance or assignment of unique identification tokens to prevent issuance or transfer of fraudulent tickets and to enable determining the identity of each ticket purchaser and subsequent ticket purchasers.

### CROSS-REFERENCES TO RELATED APPLICATIONS

None.

### BACKGROUND OF THE INVENTION

Currently, there are numerous venues worldwide that utilize some type of ticketing system to issue tickets to patrons for a variety of sporting events, concerts, shows, and other events. More recently, tickets have become available in either paper or in some type of electronic form. Conventionally, many venues release a certain amount of tickets to be available for purchase directly from the venue or through a ticket provider. However, once the ticket is sold from the venue or their representative, the venue has little, if any, control over the resale of tickets on the secondary market, or over duplication of sold tickets creating counterfeit and duplicate fraudulent tickets. As such, the venue, concert promoter and/or initial ticket provider only has control over and can manage the initial ticket sale to the purchaser.

Further, in some instances, certain individuals may be able to purchase tickets for an event from the venue with the intent of re-selling all their purchased tickets at a premium price to other individuals wanting to attend the event. These individuals who purchase tickets solely for premium resale are known colloquially as scalpers. Unfortunately for the venue or event promoter, there are no current platforms that allow the venue or event promoter to maintain a certain amount of control over the secondary market to prevent scalpers from profiting and fans from having to pay premium prices for tickets.

Accordingly, there exists a need for a system that allows a venue, event promoter, event organizer, or ticket provider to issue access rights for an event and to be able to determine the identities of each ticket purchaser or ticket holder. Further, there exists a need for ticket purchasers to transfer or re-sell their tickets to other individuals in a manner that ensures the validity of the tickets transferred or purchased. Additionally, a need exists for integration of primary and secondary ticket marketplaces, which allows for a first distribution of tickets and second distributions of tickets or transfers of tickets such that the event promoter, event organizer, or venue is capable of identifying each individual purchaser who obtain tickets from a secondary distribution.

### BRIEF SUMMARY OF THE INVENTION

As such, provided herein are systems and methods for distributing access rights for a venue. In some embodiments, the systems and methods distribute certain access rights and assign identification tokens to each right purchased or transferred. In certain embodiments, the systems and methods provided herein allow for integration of a primary and secondary access right market, wherein the venue is able to identify the identity of each access right holder, whether the access right holder purchased the access right directly from the venue or whether the access right holder purchased their access right from another individual.

Further, the systems and methods provided herein distribute access rights from the venue to a first user or purchaser and allow the first user or purchaser to transfer either a portion of or all of their access rights to another user. Furthermore, in certain embodiments, each time a distribution is made, there is a unique identification token assigned that prevents fraudulent copies of the access right and allows for secure transfer of access rights from both the primary and secondary marketplaces.

The systems and methods presented herein may, in some embodiments, enable a venue to validate the rights of the access holder, including validate the identity of the access holder, via assignment of a unique identification token.

In some embodiments, the disclosure is directed to a hosting system for distributing one or more access licenses, comprising: one or more servers in association with one or more processors, wherein the one or more servers are communicatively linked to a communications network; and a computer readable medium with one or more software instructions residing thereon, the software instructions executable by the one or more processors to direct the performance of operations comprising: distributing one or more access licenses to a first user; enabling a second user to obtain one or more of the access licenses distributed to the first user; distributing to the second user one or more of the access licenses obtainable from and distributed to the first user; assigning one or more identification tokens each time a distribution is made to the first user or second user; storing information associated with each of the one or more identification tokens in a data repository; receiving identification token information associated with the one or more identification tokens assigned from a verification device; comparing the received identification token information with information stored in the data repository to determine if the identification token is associated with an identification token that is valid; generating a validation determination that the identification token is either a valid identification token or an invalid identification token; and transmitting the validation determination to one or more of a first user device, a second user device, or the verification device.

In other embodiments, provided herein are methods for distributing access rights for a venue, comprising the steps of: receiving a request from a purchaser for one or more access rights from a venue; distributing to the purchaser one or more access rights; enabling transfer of one or more access rights from the purchaser to a user; distributing to the user one or more access rights available for transfer from and previously issued to purchaser; issuing one or more identification tokens to the purchaser or user upon distribution of one or more access rights, wherein the one or more identification tokens are stored on one or more devices associated with the purchaser or user; and verifying identification tokens as being valid or invalid.

Still in other embodiments, provided herein are computer program products comprising a computer-readable medium having program instructions residing thereon, comprising: means for enabling a primary distribution of one or more access rights to a venue; means for enabling a second distribution of one or more access rights to a venue, wherein the one or more access rights in the second distribution is one or more of the access rights from the primary distribution; and means for assigning one or more identification tokens to one or more users in possession of one or more access rights in association with said primary and secondary distributions.

### BRIEF DESCRIPTION OF THE SEVERAL VIEWS OF THE DRAWINGS

FIG. 1 is a block diagram representing an embodiment of a ticket hosting system in accordance with the present disclosure.

FIG. 2 is a block diagram representing an embodiment of an access verification system as related to the ticket hosting system in accordance with the present disclosure.

FIG. 3 is a block diagram representing an embodiment of a system for determining geolocational access rights within a venue node network in accordance with the present disclosure.

FIG. 4 is a flowchart representing an embodiment of a log-in method for verifying a user's credentials in accordance with the present disclosure.

FIG. 5 is a flowchart representing an embodiment of a method for creating a user's credentials in accordance with the present disclosure.

FIG. 6 is a flowchart representing an embodiment of a method for resetting a user's account password in accordance with the present disclosure.

FIG. 7 is a flowchart representing an embodiment of a method for editing a user's credentials via a user interface in accordance with the present disclosure.

FIG. 8 is a flowchart representing an embodiment of a method for viewing a user's tickets via a user interface in accordance with the present disclosure.

FIG. 9 is a flowchart representing and embodiment of a method for validating a user's one or more first access rights in accordance with the present disclosure.

FIG. 10 is a flowchart representing an embodiment of a method for assigning a user's one or more subsequent access rights in accordance with the present disclosure.

FIG. 11 is a flowchart representing an embodiment of a method for assigning one or more identification tokens to a ticket in accordance with the present disclosure.

FIG. 12 is a flowchart representing an embodiment of a method for enabling transfer of access rights from a first user to a second user in accordance with the present disclosure.

FIG. 13 is a flowchart representing an embodiment of a method for enabling a second user to accept the transfer of access rights from a first user in accordance with the present disclosure.

FIG. 14 is a flowchart representing an embodiment of a method for enabling the sale of access rights from a first user to a second user in accordance with the present disclosure.

FIG. 15 is a flowchart representing an embodiment of a method for displaying ticketed events for one or more venues via a user interface in accordance with the present disclosure.

FIG. 16 is a flowchart representing an embodiment a method for enabling the purchase of access rights from a first user, or a venue, or a combination thereof, by a second user in accordance with the present disclosure.

FIG. 17 is a flowchart representing an embodiment of a method for displaying one or more notifications to a user via a user interface in accordance with the present disclosure.

FIG. 18 is a flowchart representing an embodiment of a method for enabling a primary distribution of one or more access rights to a venue in accordance with the present disclosure.

FIG. 19 is a flowchart representing an embodiment of a method for enabling a secondary distribution of one or more access rights to a venue in accordance with the present disclosure.

FIG. 20 is a flowchart representing an embodiment of a method for assigning one or more identification tokens to one or more users in accordance with the present disclosure.

### DETAILED DESCRIPTION OF THE INVENTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The term “user interface” as used herein may unless otherwise stated include any input-output module with respect to the hosted server including but not limited to web portals, such as individual web pages or those collectively defining a hosted website, mobile device applications, telephony interfaces such as interactive voice response (IVR), and the like. Such interfaces may in a broader sense include pop-ups or links to third party websites for the purpose of further accessing and/or integrating associated materials, data or program functions via the hosted system and in accordance with methods of the present invention.

The term “communications network” as used herein with respect to data communication between two or more parties or otherwise between communications network interfaces associated with two or more parties may refer to any one of, or a combination of any two or more of, telecommunications networks (whether wired, wireless, cellular or the like), a global network such as the Internet, local networks, network links, Internet Service Providers (ISP's), and intermediate communication interfaces.

In some embodiments, the term “purchase” may include transactions where there is an exchange of financial value in exchange for a ticket. However, in some embodiments herein, the term “purchase” may include transactions where there is not an exchange of financial value in exchange for a ticket. For example, in some embodiments a venue may be offering tickets for free, or a user may offer to transfer a ticket to a second user as a gift and, therefore, without consideration. Thus, the user is able to obtain a ticket from the venue without having to provide any financial payment to the venue. Thus the term purchase, as used herein, covers a transaction where a purchaser or user provides financial payment in exchange for a ticket or where a purchaser or user does not provide any financial payment in exchange for a ticket. In some embodiments, the term purchase may include transactions where there is an exchange of value, but not financial value, in exchange for a ticket. For example, in some embodiments a venue may offer a ticket for purchase in exchange for requested information about the purchaser, user or other users. Further, in some embodiments, the term purchase may refer to transactions where there is no value provided in exchange for a ticket.

The term “ticket” as used herein may refer to any one of, or a combination of any two or more of, an access right for a venue, a bundle of access rights, one or more access rights in reference to a specific user, one or more access rights in reference to specific user credentials, and one or more identification tokens. Such tickets may refer to both or either access rights that may be purchased, sold, and transferred among one or more users and access rights that are specific to a user or plurality of users. In some embodiments, the term “ticket” may refer to the identification token associated with an access right or access license from a venue. For example, in embodiments where the identification token is displayed on a user device, the ticket may include the displayed identification token and any other displayed information such as a fraud prevention token or other venue information. In some embodiments, the term “ticket” may refer to visual or non-visual tokens created for verification of a purchaser's or user's one or more access rights.

As used herein the term “venue” means any area where an event may take place. In some embodiments, a venue may be a bounded or unbounded geographical area. For example, in some embodiments, the venue is a secured area where admittance is only allowed through secured entry and exit points. In other embodiments, the venue may be an area generally located around a stage, field, or event specific area. In some embodiments, a venue may be a nongeographical area such as a broadcast channel, Internet location, web page, or other non-physical, specific address by which an event can take place.

In some embodiments, the term “identification token” may be any information-bearing object that is capable of being associated with an access right or access license. For example, in some embodiments an identification token may be selected from any one or more of the following non-limiting examples: Quick Response (“QR”) code, bar code, text, photograph, image, icon, password, passkey, data string, sound, etc. In some embodiments, an identification token may be machine-readable but not readily human-readable.

In some embodiments, the term “user” may include the venue. For example, in some embodiments, a venue may wish to obtain tickets from a purchaser or first user. As such, in this embodiment the venue may be embodied as a second/secondary user and obtain tickets from a purchaser and/or first user. In certain embodiments, the venue may then provide those tickets obtained from one or more purchaser and/or first user for sale.

In some embodiments herein, the term “fraud protection token” refers to any object that prevents, dissuades, or makes more difficult the unauthorized copying, transfer, or reproduction of the ticket. In certain embodiments a ticket may include both a fraud prevention token and an identification token. Non-limiting examples of a fraud protection token include: text, photograph, image, icon, password, passkey, data string, encryption algorithm, sound, video, graphical mask, holograph, etc., and combinations thereof. In some embodiments, a fraud protection token may be readily human-readable. In some embodiments, a fraud prevention token may be presented in accordance with an identification token so as to obstruct, hamper, make difficult, or make obvious the efforts of copying or extracting an identification token from a ticket. For example, a fraud prevention token may include a moving graphical mask that obfuscates a visual identification token, or alternatively a video layered behind a visual identification token, such that a screenshot of said visual identification token would render the visual identification token useless to a scanner or otherwise indicate to a venue agent that a duplication has been made.

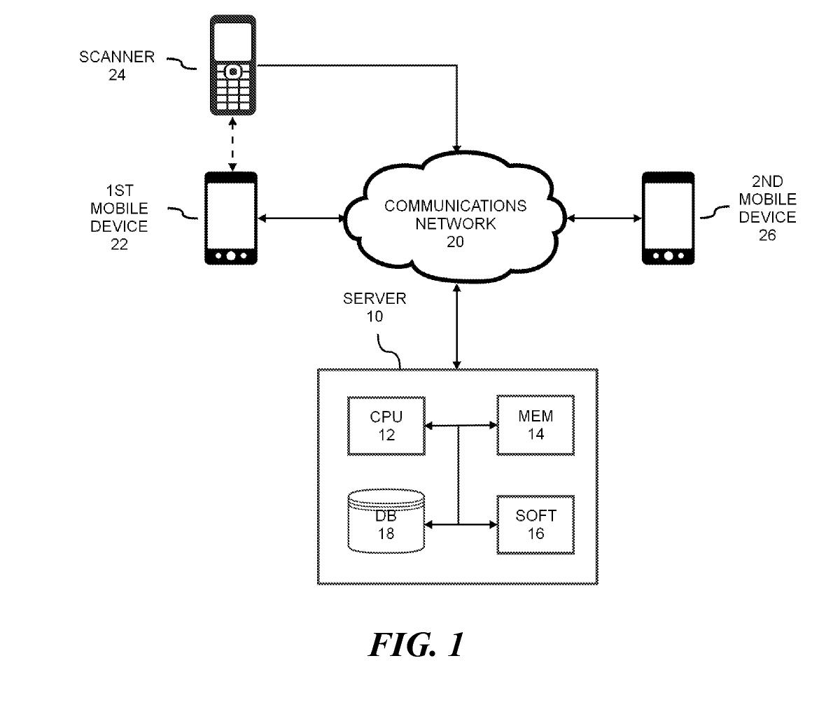

FIG. 1 is a block diagram representing an embodiment of a ticket hosting system in accordance with the present disclosure. In certain embodiments, a server system 10 is comprised of a central processing unit 12 and a storage medium or memory medium 14 with one or more program modules 16 stored thereupon. The program modules 16 may be executable by the processor to effect the exchange, storage, and management of ticket information including, for example, user accounts, venue IDs, access rights, identification tokens, sales information, exchange information, and the like. The ticket information may be stored upon one or more databases 18 which may be communicatively connected to or optionally stored upon server system 10.

The server 10 may be operatively connected to a communications network 20, the software 16 configured to receive communications across the communications network 20 from a plurality of connected mobile devices. In an embodiment, the software 16 may be configured to send and receive ticketing information across the communications network 20 to a first user's mobile device 22. In an embodiment, a user may connect to the server 10 by means of a mobile application or website portal with unique user credentials. The user credentials may be associated with the user, such as by associating an identifier with the user's name, a username, and the like; or the user credentials may be associated with the mobile device 22, such as associating an identifier with a mobile phone number, a Media Access Control (MAC) address, and the like.

In an embodiment, the software 16 may be configured to exchange ticket sales information between the plurality of connected devices. A plurality of events may be associated with one or more venues and stored on the database 18. The software 16 may be executable to display the events and venues on the various mobile devices. For example, a user may be able to select on the mobile device 22 via a user interface one or more venues and then select one or more upcoming events from said venues. The events may include, but are not limited to, entertainment events such as sporting events, concerts, comedy shows, theatrical productions, musical productions, galas, speeches, fundraising dinners, and so forth, especially where said events are commonly ticketed or otherwise restricted from general public access.

In further embodiments, each event may be associated with a plurality of access rights. Access rights may include discrete categories of rights associated with individual or group access; for example, access rights may include: one-to-one access such as reserved, individually labeled venue seats; locational access such as admission to a specific bounded area like backstage or general admission; benefit rights such as access to club member or VIP services or limited inventory; qualifier entries such as entries into halftime show contests or raffles; and other such categories for which a venue may wish to uniquely designate a group of one or more persons. One or more access rights may be bundled and associated with one another. In an embodiment, a user may be able to select one or more access rights for a particular event for purchase through the user interface of the user's mobile device 22, the access rights displayed on the mobile device by means of the software 16 transmitting the access rights information across the communications network 20 and to the mobile device 22.

In said embodiment, the user may be able to purchase access rights from a primary marketplace, wherein access rights are sold by the venue, concert promoter or other event specific ticket provider. In said purchases, the user may select one or more access rights or access rights bundles associated with at least one event and enter payment information. The software 16 may be configured to receive said purchase request and payment information, verify the purchase request and payment information, and then associate the one or more access rights purchased with the user and/or user's mobile device 22. Access rights associated with a user may be delisted from the primary marketplace such that no other user can purchase previously purchased access rights from the venue. The software 16 may optionally be configured to generate one or more tickets in association with the access rights purchased. In certain embodiments, tickets may contain at least an access rights identifier and a user identifier associating the purchased access rights to the user that purchased the access rights.

In further of said certain embodiments, tickets may also contain, or the access rights and user identifiers may also serve to function as, a fraud prevention token for purposes of verifying a user's access at the venue event. A user may be able to display or broadcast the access rights or fraud prevention token via the user interface of the first mobile device 22 when present at a venue. A venue-centric scanner device 24 may be configured to receive and authenticate the access rights or fraud prevention token, thereby allowing the user access to the venue event. The scanner device 24 may be optionally configured to exchange information with the server 10 via the communications network 20. The scanner device 24 may be alternatively and optionally configured to exchange information with the server 10 via a venue server, not depicted, connected to the communications network 20.

In an embodiment, the scanner device 24 may be able to determine and verify a ticket displayed on the screen of the first mobile device 22. The ticket may be configured as a combination of an identification token and a fraud prevention token such that the operator of the scanner device 24, or the scanner device 24 itself, may determine that the ticket is being displayed via the user interface of an authorized application instead of an unauthorized screenshot. In a further embodiment, the combination of an identification token and fraud prevention token may include overlaying the identification token over the fraud prevention token or embedding the identification token in the fraud prevention token. For example, in some embodiments, the fraud prevention token may be a displayed moving image in which the identification token is placed over or embedded. Other visual or non-visual tokens may be used. For example, access rights credentials may be exchanged between the mobile device 22 and scanner device 24 by means of near-field communication (NFC), radio frequency identification (RFID), Bluetooth, Wi-Fi, audio, infrared (IR), or any other input/output found among mobile devices.

In an embodiment, the user may be able to purchase, sell, or transfer access rights via a secondary marketplace, wherein access rights that have been purchased by a user and therefore no longer listed on the primary marketplace may be bought, sold, or exchanged with other users. For example, a first user who has purchased certain access rights via the user's mobile device 22 may wish to sell said access rights. The software 16 may be configured to associate the purchased access rights in the database 18 as listed on the secondary marketplace. In said example, a second user on a second mobile device 26 may desire to purchase the access rights listed for sale by the first user; the software 16 may be configured to transmit the secondary marketplace information including the access rights listed for sale by the first user to the second mobile device 26, the second mobile device displaying said secondary marketplace information on a user interface. The second user may purchase the access rights listed for sale by the first user as well as any other access rights listed for sale by other users on the secondary market, whereupon the software 16 may receive the purchase request and payment information, verify the purchase request and payment information, and then disassociate the access rights from the first user selling the tickets and associating the access rights with the second user purchasing the tickets.

In embodiments where tickets and/or ticket identifiers are created, the software 16 may be configured to assign new tickets and/or ticket identifiers based upon the identity of the second user. In certain embodiments, the software 16 may be configured to transmit for simultaneous display both primary and secondary marketplace information on the user's mobile device 22, such that a user can purchase from either or both markets.

In another embodiment, the software 16 may be configured to allow a first user on a first mobile device 22 to transfer access rights to a second user on a second mobile device 26. In this embodiment, the first user may select one or more of the access rights or access rights bundles associated with the first user, which for intents and purposes of this embodiment may be considered as one or more tickets wherein the tickets are a bundle of one or more access rights associated with a user, for transfer to a second user. The first user may select said tickets on the first mobile device and then enter the identity of the second user to receive the selected tickets. In certain embodiments, the first user may identify the second user by entering one or more of the second user's user credentials, including, for example: first and last name, username, e-mail address, phone number, and the like. The software 16 may then send a notification to the second user's mobile device 26 that the first user desires to transfer said tickets. In an embodiment, the second user may select to accept or otherwise to reject the transfer of said tickets. If the second user accepts the tickets, then the software 16 may disassociate the access rights from the first user transferring the access rights and associate the access rights with the second user receiving the access rights. The software 16 may also generate new tickets for the transferred access rights in association with the new user.

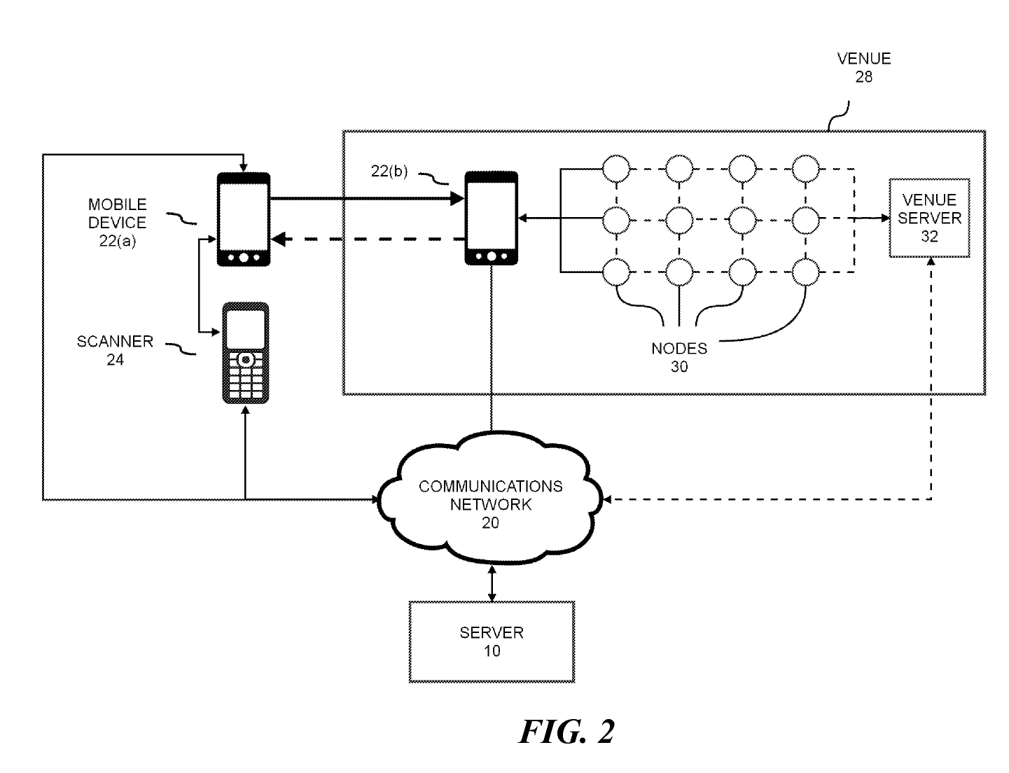

FIG. 2 is a block diagram representing an embodiment of an access verification system as related to the ticket hosting system in accordance with the present disclosure. FIG. 2 may be interpreted as an embodiment in reference to FIG. 1. A server 10 is connected to a communications network 20 and is configured to transmit a ticket to a mobile device 22 for purposes of accessing a venue 28. The ticket may be valid for a venue event of a specific duration, may allow for a number of entries, or otherwise. The ticket transmitted to the mobile device 22 may be displayed or otherwise presented for verification of the associated ticket by a venue-centric scanning device 24. A mobile device associated with an unverified ticket 22(a) may display or transmit the ticket or a portion of the ticket such as an identity token to the scanning device 24 outside or at the portal of a venue 28. In certain embodiments, a venue 28 may include access to non-geolocational benefits such as access to services; for example, a user may have access rights to a complimentary beverage from any one of a given number of bars or concession stands in a venue.

The scanning device 24 may scan the ticket on the mobile device 22(a) and verify that the ticket is valid. Valid tickets may be stored on the scanning device 24 prior to the event, or the scanner may determine valid tickets real-time in direct or indirect connection to the server 10 via the communications network 20. The unverified ticket associated with the mobile device 22(a) will then become a verified ticket associated with the mobile device 22(b), wherein in an embodiment the access rights of the ticket associated with the mobile device 22(b) are flagged as verified for access to the venue 28. The verification of a ticket may optionally be transmitted to the mobile device associated with a verified ticket 22(b) such that the device retains information that the user's ticket has been verified. In another embodiment, the mobile device itself may be verified for access to the venue. The verification may be transmitted via the scanning device 24 using the same or similar protocol to verify the ticket. Alternatively, the verification may be transmitted via the communications network 20 to the mobile device 22 and to the server 10. In certain embodiments, verification transmission may be temporarily delayed when no connectivity to the server is possible, the verification information stored upon the scanning device 24 until connection to the server 10 is restored and the transmission completed. In alternative embodiments, the verification information may be transmitted to a venue server, not depicted, for temporary verification management until said verification information can be transmitted to the server 10.

In certain embodiments, the mobile device associated with a verified ticket 22(b) may display an alternative embodiment of the ticket for cursory verification that the user of the mobile device 22(b) is permitted within the venue space 28. For example, color may be used to indicate the status of ticket, where unverified tickets may be displayed as an identification token on a red background and verified credentials may be displayed as an identification token on a green background. In another example, the identification token itself may be displayed in different colors or configurations such that various colors or configurations or a combination thereof indicate whether the ticket is verified or unverified. In a third example, the fraud prevention token may be displayed in different colors or configurations, or alternatively the fraud prevention token may be changed entirely, such that the presence or absence of fraud prevention tokens in different colors or configurations, or combinations thereof, indicates whether the ticket is verified or unverified. The cursory verification embodiment described above may be contemplated in various embodiments of systems and methods without reference to distribution of tickets between a first and second user and methods described herein.

In certain embodiments, various colors or configurations may indicate whether one or more access rights associated with a ticket have been verified. For example, a red ticket may indicate that no access rights of a ticket have been verified; a yellow ticket may indicate that some of the access rights of a ticket have been verified; and a green ticket may indicate that all of the access rights of a ticket have been verified. In certain embodiments, various colors or configurations may indicate the presence of certain access rights. For example, certain colors, patterns, icons, and the like may be used to convey that a ticket may be associated with an access right that a ticket without said colors, patterns, icons, and the like may not, such that a backstage pass ticket may have a different display configuration than a balcony seat ticket. In another example, certain colors, patterns, icons, and the like may be used to convey that a ticket has undergone one or more subsequent check-in and check-out iterations, such that a ticket not checked in may be red, a ticket checked in may be green, a ticket checked in and then subsequently checked out may be yellow, and a ticket checked in, checked out, and then checked in again may be blue.

Visual status display such as color or configuration of visual tokens as described above may be enabled for cursory determination of a verified ticket, though other non-visual status verification methods may be used for cursory or non-cursory determination of a verified ticket, such as audio signal, radio signal, vibration, NFC, RFID, Bluetooth, Wi-Fi, and the like.

In certain embodiments, a verified user device 22(b) may be configured via an application to interact geolocationally with the venue 28 by means of one or more nodes 30 placed about the venue 28. The nodes 30 may be independent of one another or configured as a part of a network. Nodes may be, for example, NFC tags, RFID tags, iBeacons, QR codes, or other devices capable of interacting with the mobile device 22 either actively or passively. In an embodiment, nodes may play similar or the same functions as a scanning device 24, verifying access rights and granting access to geolocational or service-oriented access to areas, services, and benefits within the venue 28. For example, a merchandise booth may have one or more nodes capable of interacting with mobile devices associated with verified identity tokens 22(b) within a certain geographical radius of the booth. In said example, the booth nodes may be configured to deliver, or otherwise be passively detected, notifications regarding specials, sales, inventory quantities, and the like. In a further embodiment, both nodes may be configured to interact with certain access rights such that certain users may have personalized notifications pertaining to specific access rights; for example, certain users may have predetermined access rights granting them a complimentary beverage from one or more venue bars and/or concession stands. In another example, certain users may be granted additional access rights based upon certain factors, such as granting a number of mobile devices 22(b) within a certain area a limited time offer.

In an embodiment, node-based access rights may be determined and/or granted via a venue server 32. In said embodiment, the venue server 32 may be configured to execute one or more algorithms effective to determine for a plurality of mobile devices associated with verified identity tokens 22(b) whether said mobile devices should be granted access rights in accordance with the one or more nodes 30. For example, the venue server 32 may be configured to grant access rights associated with certain nodes to encourage traffic to under-trafficked nodes, such as providing sales to underperforming businesses within the venue space 28. Alternatively, the venue server 32 may be configured to dissuade traffic to over-trafficked nodes; for example, a venue server 32 may be capable of determining that too many user devices 22 are located near nodes 30 proximate to a second floor bathroom and may generate a notification to user devices 22 that the second floor bathrooms are full but that the first floor bathrooms do not have a line, as determined by nodes proximate to the first floor bathrooms.

The venue server 32 may be further configured to grant access rights based upon heuristically determined information from the nodes 30 and/or mobile devices 22(b). For example, the venue server 32 may be configured to notice that a mobile device 22 has been waiting near a node 30 associated with a queue and then leaves without passing into the range of a second node 30 associated with a booth, such as when a user waits in a long line and then abandons the line in frustration that it is not moving fast enough; the venue server 32 may grant access rights designed to encourage that the mobile device 22 remain in queue, such as offering a sale or other incentive.

The venue server 32 may be configured to generate notifications deliverable to the mobile devices associated with verified identity tokens 22(b) through a communications network 20 or through the nodes 30. The nodes 30 may be individually configured, such as through passive interaction like NFC; the nodes 30 may be networked, such as through Wi-Fi, mesh network protocols like ZigBee, and the like; or a combination of active and passive nodes 30 may be used.

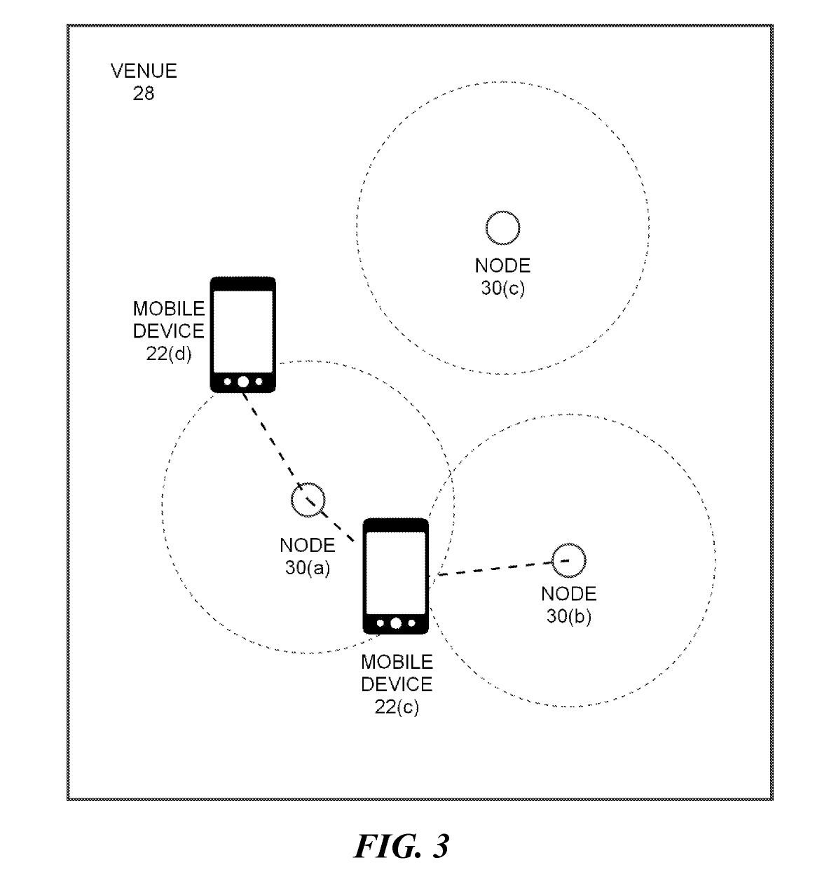

FIG. 3 is a block diagram representing an embodiment of a system for determining geolocational access rights within a venue node network in accordance with the present disclosure. FIG. 3 may be interpreted as an embodiment in reference to FIG. 2. One or more mobile devices 22 may be located inside a venue 28 with a plurality of nodes 30 placed throughout. The nodes 30 may be configured to determine the geospatial location of the mobile devices 22 within the venue 28. Geospatial location for each mobile device 22 may be determined by triangulation between nodes 30, including triangulation between the radial distance measured between three nodes 30 or the presence and radial distance between two nodes 30, or other such methods of two- or three-dimensional determination. For example, a first mobile device 22(c) may be proximate to a first node 30(a) and a second node 30(b), while a second mobile device 22(d) may be proximate only to the first node 30(a). Certain access rights associated with node 30(b) may be granted to mobile device 22(c) but not to mobile device 22(d).

In an embodiment, certain access rights may be granted to the one or more mobile devices 22 based upon the proximity of said mobile devices 22 to one or more specific nodes 30. For example, the first mobile device 22(c) is closer to node 30(a) than the second mobile device 22(d); a venue manager may be able to determine from the node 30(a) or from the plurality of mobile devices 22 a ranking of proximate devices, wherein mobile device 22(c) is ranked above mobile device 22(d). In further said example, the venue manager may be able to determine a queue based upon the proximity of said mobile devices 22 to the node 30(a), allowing the venue manager to pull up identification information and/or access rights associated with first mobile device 22(c) and second mobile device 22(d) in visual or categorical order. In an embodiment, the aforementioned queue may be used to quickly pull up access rights information for a plurality of mobile devices 22 in line to access a venue 28 for an event. In said embodiment, identification information such as a user photograph may be displayed on the user interface of a venue-based verification device such as a scanner or tablet, allowing a venue manager to visually determine in order of approaching users whether the associated identification information of the user devices corresponds with the users currently approaching. For example, in some embodiments an ordered list of attendees is dynamically generated as mobile devices associated with access rights or access licenses approach the venue. In an embodiment, an ordered list of attendees may be determined in accordance with the proximity of each of the one or more users' mobile devices 22 to one or more nodes 30.

In an alternative embodiment, a sports venue's food vendor may be able to determine said identification information such as user photograph and order information so that the vendor can quickly determine for each approaching user which food order goes to which respective user. In another alternative embodiment, a waiter may be able to determine said identification information such as a user seat and order information to verify which plates go to which users at a dinner event. Said embodiments and other embodiments may be implemented with augmented reality technology such that a camera device may compare the faces of approaching users with the photographs of users and display on a user interface identification information and access rights information associated with users within the field of view of the camera whose mobile devices 22 are within range of a specified node 30.

In yet another embodiment, mobile devices 22 may be able to broadcast visible nodes 30 via a communications network to other mobile devices 22 or a server such that the server or other mobile devices 22 may be able to locate said devices in the venue 28. For example, a user may wish to locate friends and acquaintances within a venue 28 and may be able to determine their locations based upon their proximity to event nodes 30.

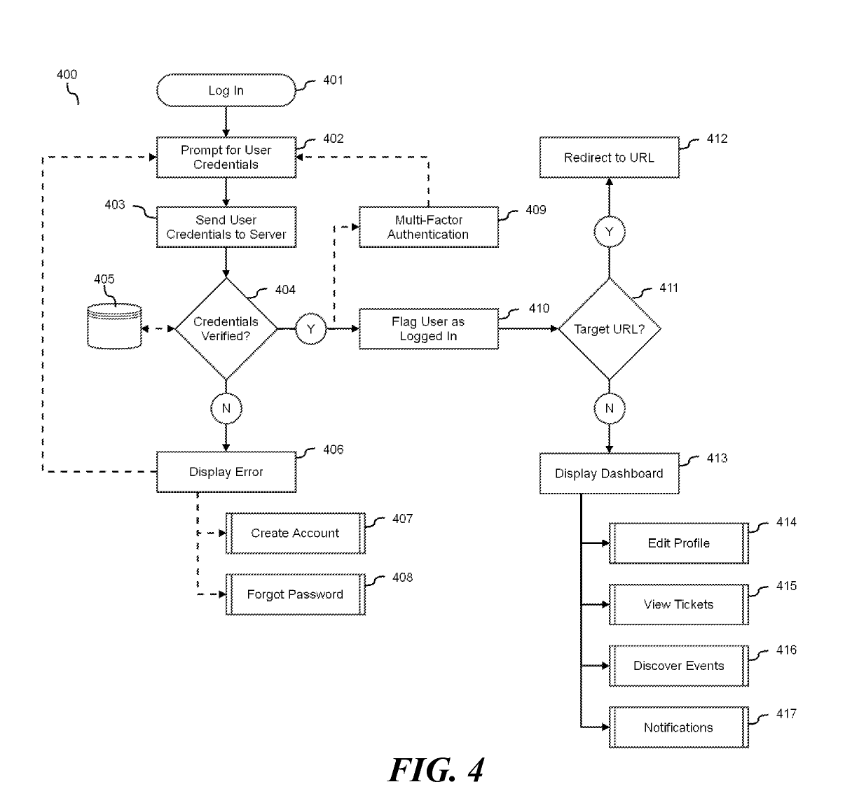

FIGS. 4 through 17 may refer collectively to an embodiment of a computer implemented method for ticket hosting. The methods may be interpreted as standalone or in reference to one another where indicated.

FIG. 4 is a flowchart representing an embodiment of a log-in method for verifying a user's credentials in accordance with the present disclosure. The method 400 begins at a first step 401 when a user initiates or is otherwise prompted to complete a log-in request by a ticket platform server. The method continues to step 402 when the user is prompted for user credentials. In an embodiment, user credentials may be in the form of a user account, such as a username and associated password. In an embodiment, the prompt may occur through a user interface such as that of a mobile application or web interface. In certain embodiments, credentials may be automatically generated from the user device used to facilitate the prompt; for example, log-in credentials may be kept in the form of cookies, access keys, and the like. In one of said certain embodiments, a prompt may be automatically completed by means of securely authenticating the telephone number or MAC address of a mobile device. In another embodiment, user credentials may include one or more call-and-response security factors, such that a code is delivered to a user's mobile device, and the user is prompted to enter said code.

In step 403, the user credentials are obtained and submitted to the server. In some embodiments, the user credentials may be transmitted from the user device and to the server via a secure, encrypted connection over a communications network. Upon receiving the credentials, the server will verify the credentials (step 404). In an embodiment, the server will compare the received credentials with stored user credentials on a communicatively connected user credential database 405. If the received credentials do not match the associated user credentials on the user credential database 405, then the server will generate an error for display on the user's log-in device (step 406). In an embodiment, the server may again prompt for user credentials and return to step 402.

In certain embodiments, multiple types of error messages may be generated depending on the cause of the rejected verification. For example, if a username is not found on the user credential database, an error may be sent to the user device stating that the given username cannot be found. In an embodiment, a user may be requested to create an account where a username has not been found (step 407). Step 407 may in certain embodiments be embodied by or continue in accordance with method 500 for creating a user's credentials. In another example, if a username is found but the received password does not match the associated password, or the hash value of the received password does not match the hash value of the associated password, then an error may be sent to the user device stating that the given password does not match the password on file. In an embodiment, a user may be prompted to reset his or her password in the event of one or more password errors (step 408). Step 408 may in certain embodiments be embodied by or continue in accordance with method 600 for resetting a user's password account password.

In an optional embodiment, the user may be prompted in sequence for more than one user credentials, wherein once the server verifies the credentials as per step 404, the user is prompted for another set of user credentials as per step 402, which will again be sent to the server via step 403 and verified via step 404 (optional step 409). For example, the user may first be prompted for a user name and password and then upon verification prompted for a call-and-response security factor sent to a user's mobile device which the user must enter and send to the server for additional credential verification. This embodiment contemplates multi-factor security authentication.

If prompted user credentials are verified, then the server may flag the user as logged in (step 410). In an embodiment, the server may transmit to the user login credentials, such as for example cookies, for purposes of identifying the user as logged in. Once the user has successfully logged in, the server may proceed to step 411 and determine whether a target URL has been specified. For example, in certain embodiments a user may have been prompted to log in upon accessing a certain page. In some of said certain embodiments, the server may retain or subsequently determine the page that the user had accessed prior to being directed to the log in process.

If a target URL exists, then the system may direct the user to the determined page (step 412). If no target URL exists, then the server may direct the user to an application dashboard (step 413). An application dashboard may comprise links for a user to edit profile information (step 414), view tickets that the user owns (step 415), view ticketed events for venues (step 416), and view notifications if any (step 417). Steps 414 through 417 may in certain embodiments be embodied by or continue in accordance with methods 700, 800, 1500, and 1700, respectively and listed herein.

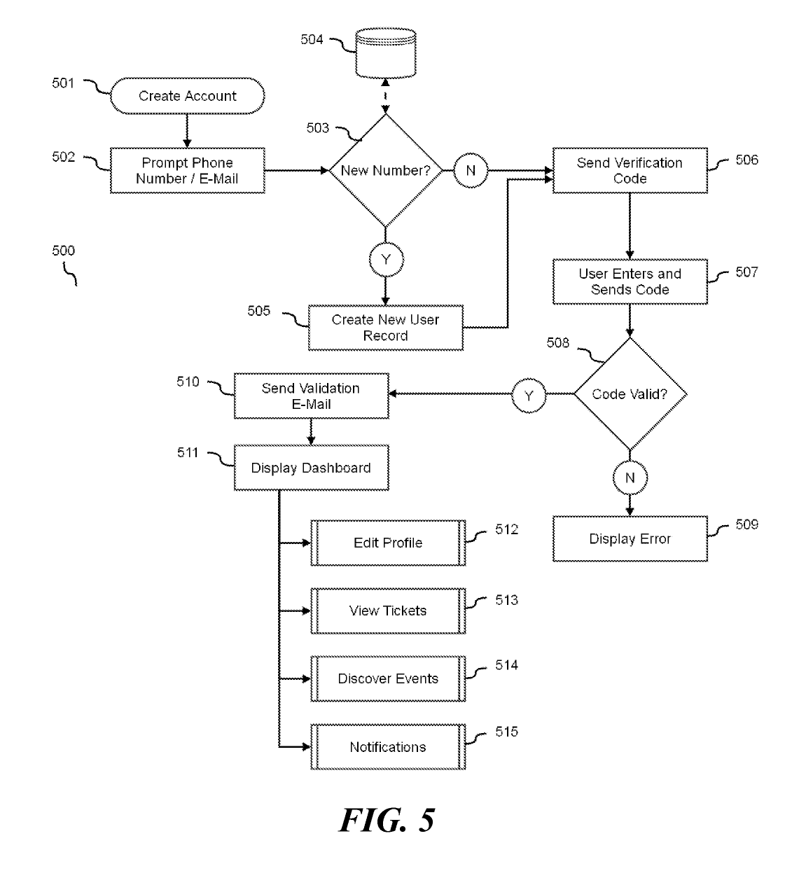

FIG. 5 is a flowchart representing an embodiment of a method for creating a user's credentials in accordance with the present disclosure. The method 500 begins at a first step 501 when a user initiates or is otherwise prompted to create a user account via the ticket platform server. A user account may comprise one or more user credentials, such as, for example: username, password, and various profile information. In an embodiment, profile information may be information editable by a user. Once the account creation process has been initiated, the user may be prompted for one or more user credentials. In an embodiment, the user may be prompted for profile information, the remaining user credentials automatically generated or otherwise determined by the system. In an embodiment, user credentials may include a unique user identifier such as a username, phone number, or e-mail address. In an ideal embodiment, the server will request both the user's phone number and e-mail address, which the user may subsequently provide and submit to the server.

In step 503, the server determines whether the user-provided account is new or already contained within a list of active user accounts. In an embodiment, the server may check the submitted account information with stored account information on a communicatively connected account database 504. If the account is new, then the server will create a new user record including the submitted account and the submitted, associated user credentials (step 505). For example, a new user record may contain an e-mail address and user-provided phone number in association with the e-mail address. If the account is not new, then the server may associate the submitted account information with user credentials on the account database 504. In certain embodiments, the server may store the new user record in the account database 504. In certain embodiments, the new user record may be stored temporarily for purposes of credential verification for subsequent association with a new user account upon or following said credential verification.

Upon creating a new user record, or if the user-provided account is already contained within a list of active user accounts, then the system may proceed to step 506 whereupon the server sends a verification code to a user's verification device. A user verification device may ideally be a cellular network-connected smart phone, the verification ideally code transmitted via an SMS message to the smart phone. Certain embodiments may skip or otherwise not include the code verification process, wherein the system proceeds to step 511 as described herein. In ideal embodiments, the user must respond with the verification code from the verification device (step 507). In alternative embodiments, the verification code may automatically be verified by the verification device without user input, wherein step 507 is bypassed and the system proceeds to step 511 as described herein.

In embodiments where a verification code is returned to the server in accordance with step 507, the server then determines whether the verification code is valid (step 508). If the code is not valid, the system proceeds to step 509 whereupon the server will generate an error for display on the account creation user interface. If the code is valid, the system may proceed to step 510 whereupon the server will send a validation confirmation to the user-provided e-mail address. The server may optionally proceed to step 511 and direct the user to an application dashboard. In certain embodiments, the application dashboard may be the same or similar application dashboard as described in step 413 of method 400. The application dashboard may comprise links for a user to edit profile information (step 512), view tickets that the user owns (step 513), view ticketed events for venues (step 514), and view notifications if any (step 515). Steps 512 through 415 may in certain embodiments be embodied by or continue in accordance with methods 700, 800, 1500, and 1700, respectively and listed herein.

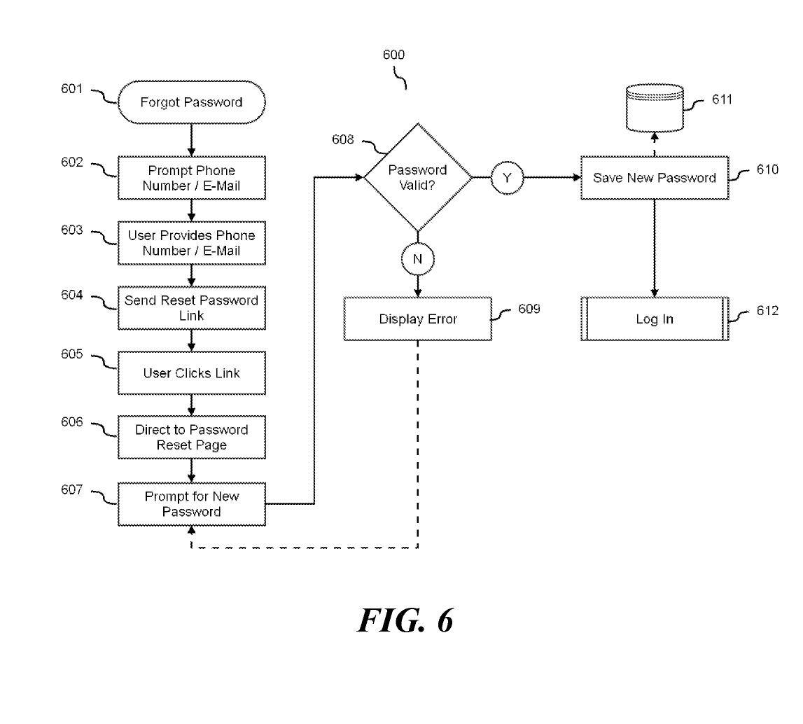

FIG. 6 is a flowchart representing an embodiment of a method for resetting a user's account password in accordance with the present disclosure. The method 600 begins at step 601 when a user selects a password reset option for an associated user account and that intent is transmitted to the server. Upon receipt of the reset request, in step 602 the user may be prompted for certain user account information such as the phone number and e-mail address of the associated user account. In step 603, the user may provide the requisite account information such as the phone number and/or e-mail address of the associated user and submit that information to the server. Upon receipt of the submitted information, the server may proceed to step 604 and send a URL to a password reset page via an e-mail to the e-mail address of the associated user account. In some embodiments, the server may verify that the phone number and/or e-mail address match are associated with an active user account before proceeding to step 604.

In step 605, the user may open the e-mail and select the hyperlink. In certain embodiments, the user may navigate to the password reset page by clicking on the link directly or by copying the text and pasting it into a web browser. Upon user action, in step 606 the user may be directed to the password reset page for the associated account. In some embodiments, the URL may be unique to the iteration of method 600 such that no other user can or is likely to have access to the URL. In certain embodiments, the URL may expire after a certain duration of time or after a certain number of page accesses.

In step 607, the server may upon the password reset page prompt the user for a new password, wherein the user types and submits a password to the server. In step 608, the server may then determine whether the submitted password is valid based upon certain password parameters. For example, a server may place certain limitations upon passwords such that passwords cannot be more or less than a certain number of characters, cannot contain certain characters or must contain certain character types, cannot be the same as one or more previous passwords, and the like. If the submitted password does not meet the password parameters, then the server may generate an error message to the user indicating that the submitted password does not meet the password parameters. In certain embodiments, the process may be real-time, such that an error message is displayed until a user has entered a valid password.

Once a valid password has been submitted, the server may continue to step 610 and save the new password in association with the user account on a user account or user credential database 611. In some embodiments, the server may store the password in an encrypted format such as a hash such that the plain-text password is not readily accessible. Once the new password has been stored in association with the user account, the user may be directed to log in such as via the log in method embodied by or in accordance with method 400 described above.

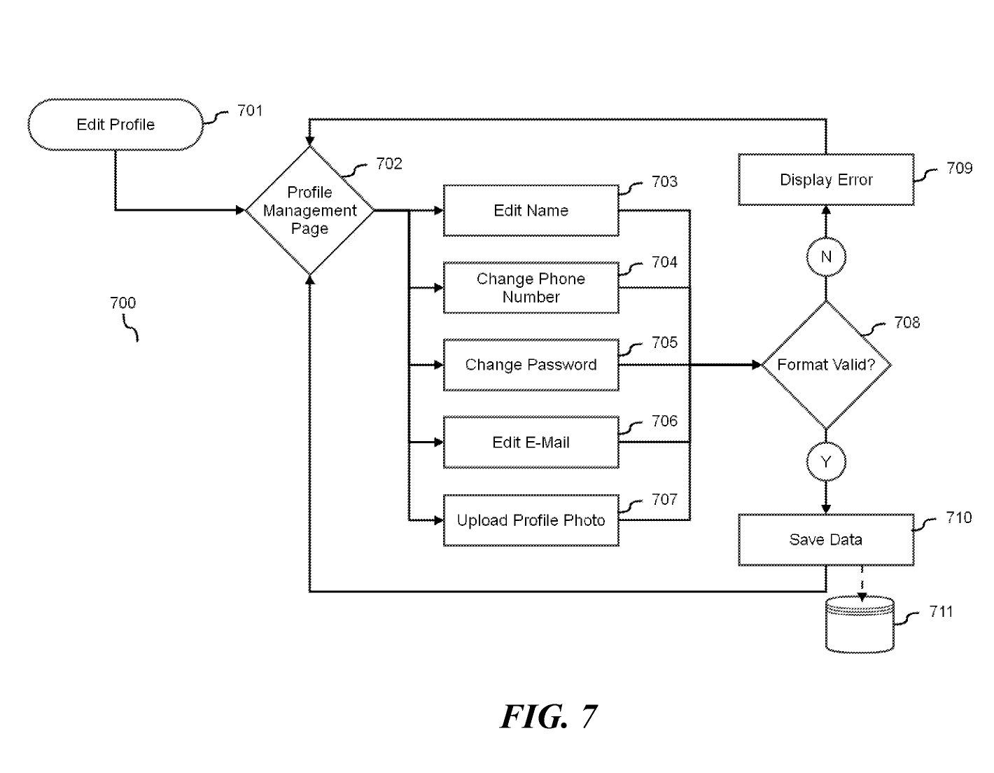

FIG. 7 is a flowchart representing an embodiment of a method for editing a user's credentials via a user interface in accordance with the present disclosure. The method begins at a first step 701 when a user initiates or is otherwise prompted to edit user credentials associated with the user's account. The method continues in the next step 702 wherein the user is directed to a profile management page. The profile management page may contain forms for or links to forms for editing one or more user credentials. The user may select one or more of the user credentials and update said user credentials from the profile management pages or subsequent credential pages.

The user may enter new credentials for one or more user credentials including the user's name (step 703), the user's phone number (step 704), the user's account password (step 705), the user's e-mail address (step 706), and the user's account profile photograph (step 707). Upon the user's entry and submission of the updated user credentials, the server may proceed to step 708 and verify that the one or more submitted credentials meets the respective credential's unique credential parameters. For example, credential parameters for a name may include formatting limitations, dictionary exclusions, character limitations, and length requirements; phone number may include formatting limitations and character limitations; profile photographs may include formatting limitations, size limitations, dimension requirements; and so forth.

For submitted user credentials that do not meet the credential parameters, the server may generate an error to display to the user (step 709) ideally explaining that the one or more credentials failed to meet the credential parameters. The system may optionally direct the user back to the profile management page of step 702. For submitted user credentials that meet the credential parameters, the system may in step 710 accept the user credentials and save accepted credentials in association with the user account on a user account database 711. In certain embodiments, the server may receive a plurality of submitted user credentials in a single submission and accept valid credentials and reject invalid credentials simultaneously, performing steps 708 through 710 in concert for each of the submitted credentials. In an embodiment, the server may overwrite previous credentials stored in association with the user account on the user account database 711. In alternate embodiments, the server may store the submitted valid credentials in addition to previous credentials. The system may optionally direct the user back to the profile management page of step 702.

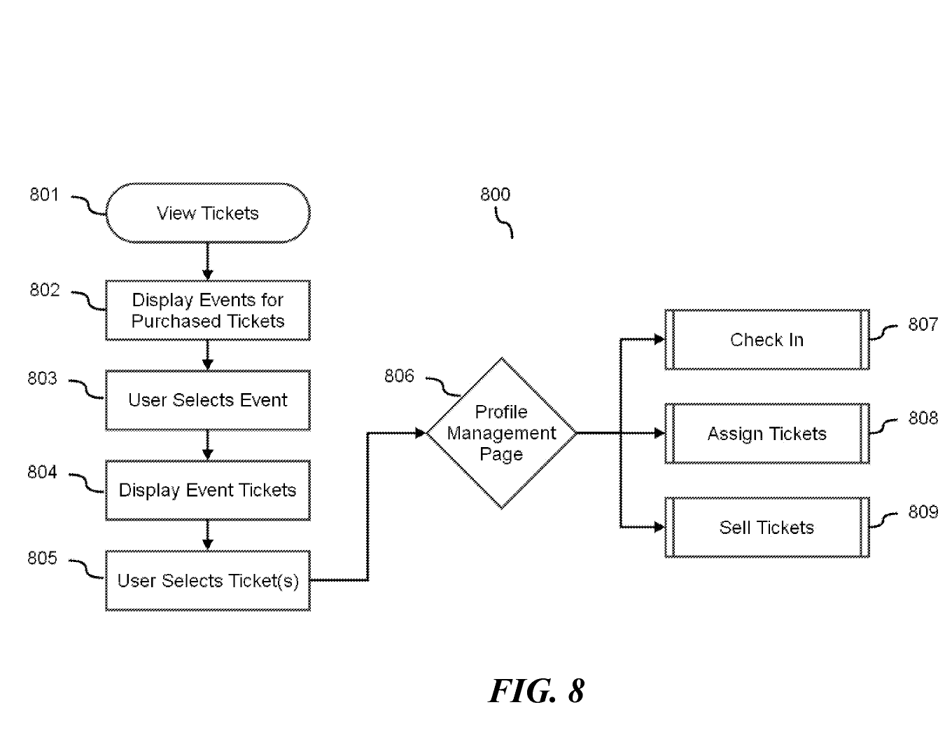

FIG. 8 is a flowchart representing an embodiment of a method for viewing a user's tickets via a user interface in accordance with the present disclosure. The method 800 begins at a first step 801 wherein a user requests to view tickets associated with the user's account. In an embodiment, the user request may be made via user selection of a link, item, or button on a user interface of a mobile application. Upon the user's request, the application may continue to step 802 and display events associated with the tickets or access rights associated with the user account. The user may in step 803 select one or more of the displayed events and request ticket information pertaining to those events. The application may continue to step 804 wherein the application displays user-associated tickets also associated with the one or more user-selected events. In certain embodiments, tickets may be bundled as single ticket items. For example, a single event for which a user has four general admission tickets may optionally bundle the tickets as a single ticket item.

In step 805, the user may select a ticket or ticket item. The application may then display a ticket management page for the user associated with the selected ticket (step 806). The ticket management page may include user-selectable options such as an option to check into the venue event with the selected ticket or ticket item (step 807), an option to assign a ticket item to another user (step 808), and an option to sell the selected ticket or ticket item on the secondary market (step 809). Steps 807 through 809 may in certain embodiments be embodied by or continue in accordance with methods 900, 1200, and 1400, respectively and listed herein. In certain embodiments, options may not be displayed or may be disabled and visually indicated as such where access rights for a ticket or ticket item do not include a user's exercising of said options or said access rights have not yet vested. For example, option 809 for selling tickets on a secondary market may be disabled where a venue has prohibited the secondary market sale of said tickets for an event. In another example, the check-in option may be disabled for a period of time until a specific duration before the event start time.

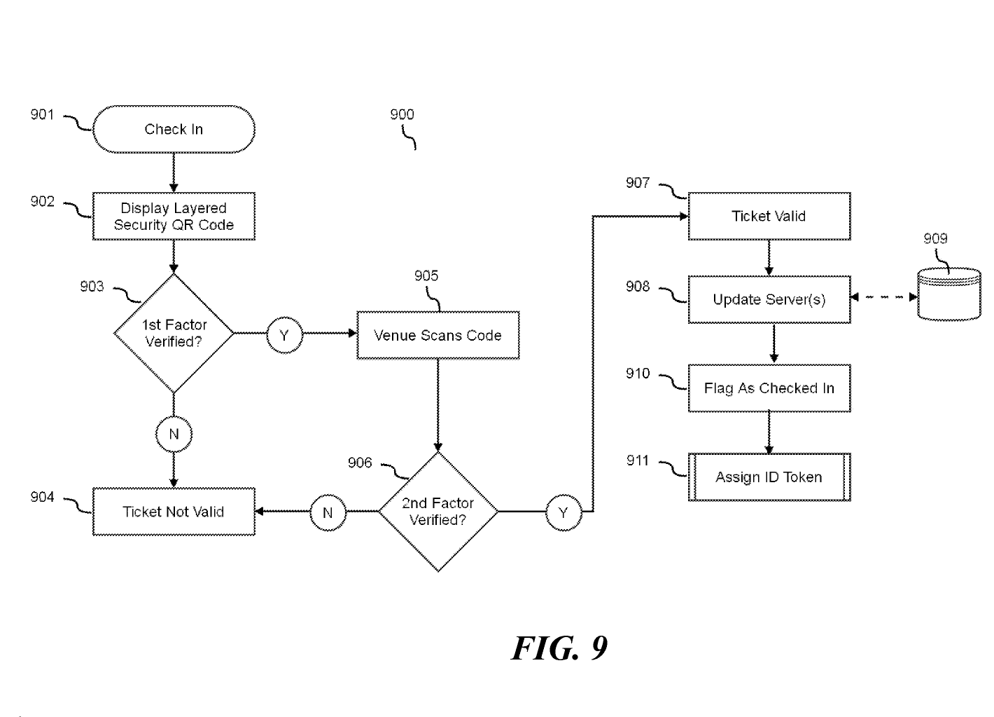

FIG. 9 is a flowchart representing and embodiment of a method for validating a user's one or more first access rights in accordance with the present disclosure. The method 900 begins at a first step 901 wherein a user requests to check in for an event. In certain embodiments, the user may request to check in pertaining to a specific event, ticket, ticket item, or group of tickets. In certain embodiments, a user may initiate a check in request based upon contextual information pertaining to the user's mobile device; for example, a user check in may automatically initiate when a user is within a certain geospatial location such as at or near the event venue and within a certain time frame such as on or before the event start time. In some embodiments, a user may indicate into which event he or she is requesting to check prior to or during this step.

In step 902 and in response to a user's check-in request, the application may display or otherwise transmit one or more identification tokens associated with the tickets and/or access rights of the determined event. In certain embodiments, one or more identification tokens may be generated for one or more tickets, ticket items, and/or access rights. For example, where a user has four tickets granting four individuals access to a venue, a single identification token may be generated for all four tickets, or alternatively four identification tokens may be generated for each ticket.

Identification tokens may in certain embodiments be displayed as or embedded on the display in the form of an e-ticket. In an embodiment, identification tokens may comprise a QR code layered over a moving video upon the display of a user's mobile device. In some embodiments, identification tokens may further include at least one human-readable verification factor and one computer-readable verification factor. In the aforementioned example, the moving video would be a human-readable factor while the QR code would be a computer-readable factor. In alternative embodiments, non-visual verification factors may be used in addition to or as alternatives to visual verification factors, such as security tokens, verification codes, and the like transmitted through communications protocols such as: NFC, RFID, Bluetooth, Wi-Fi, audio, IR, and so forth.

Following the display of the one or more identification tokens, the user may present the one or more tokens to a venue access agent for verification, whereupon the venue access agent initially determines whether at least the first factor of the identification token is verified. In some embodiments, the first verification factor may include the human-readable verification factor, such as, for example, the moving video background of a video/QR identification token combination. The human-readable factor may be configured to enable the venue access agent to determine that the identification token has been presented via an authorized application on the user's mobile device. In alternative embodiments, the first verification factor may be computer-readable and may be the only verification factor of the identification token.

If the first factor is not verified by the venue access agent, then the ticket is deemed invalid or faulty (step 904) where the venue access agent may optionally deny the user access to the venue. If the first factor is verified by the venue access agent, then the method may continue to step 905 where the venue access agent proceeds to verify the second verification factor. The second verification factor may be a computer-readable verification factor such as for example a QR code, bar code, or other computer-implemented token verifiable by a mobile verification device such as a ticket scanner or specialized tablet. If the second factor is not verified by the venue access agent, then the ticket is deemed invalid or faulty (step 904) where the venue access agent may optionally deny the user access to the venue. If the second factor is verified by the venue access agent, then the method may continue to step 907 wherein the ticket is deemed valid. In certain embodiments an identification token may only be designed to contain a single verification factor, wherein the verification process for the absent first or second factor is bypassed. In alternative embodiments, more than two verification factors may be used, wherein each factor contains its own verification process with success proceeding to subsequent and cumulative validity (i.e. step 907) and failure resulting in immediate invalidity (i.e. step 904).

When a ticket has been verified, it will be deemed valid (step 907) and a user may be permitted to enter the venue for the event in accordance with the user's access rights. Upon validation, one or more ticket servers may be updated with record of validation (step 908). In an embodiment, the user's mobile device may transmit via a communications network the ticket validation to a network-connected ticket server, whereupon the ticket server will store the ticket validation in a ticket status database 909. In an alternative embodiment, the venue access agent's verification device may transmit via a communications network the ticket validation to the network-connected ticket server. In certain embodiments, validation may be transmitted to and stored upon a venue server. In certain embodiments, transmission to the one or more servers may be temporarily delayed and stored on the respective transmitting device for later submission, such as when the transmitting device gains subsequent access to a communications network.

In step 910, the one or more presented tickets and associated user may be flagged as checked in to the event. In embodiments, the user's mobile device may be updated with the one or more tickets' and or user's checked-in status and subsequently notify the user of successful check-in. For example, the mobile device may generate an audio and/or visual notification upon determination of the user's checked-in status, such as playing a chime and/or changing the background or icon color on the mobile device display. In certain embodiments, the mobile device may be updated from the one or more ticket servers by means of a communications network or communications protocol. In alternative embodiments, the mobile device may be updated from the scanner verification device by means of a communications network or communications protocol.

In step 911, the server may assign a new identification token for the one or more tickets and/or ticket items. Step 911 may be embodied by or performed in accordance with method 1100 described herein. In certain embodiments, the completion of step 910 wherein the ticket is flagged as checked in may update or modify the user's access rights for the venue. For example, a venue may allow a user to check out of the venue during the event's duration and gain subsequent access as embodied in method 1000 described herein; may allow a user access to one or more event services such as access to digital content; and may allow a user access to one or more event networks such as a Wi-Fi network or node network.

The method 900 may be further contemplated in various embodiments of systems and methods without reference to distribution of tickets between a first and second user and without reference to other methods described herein.

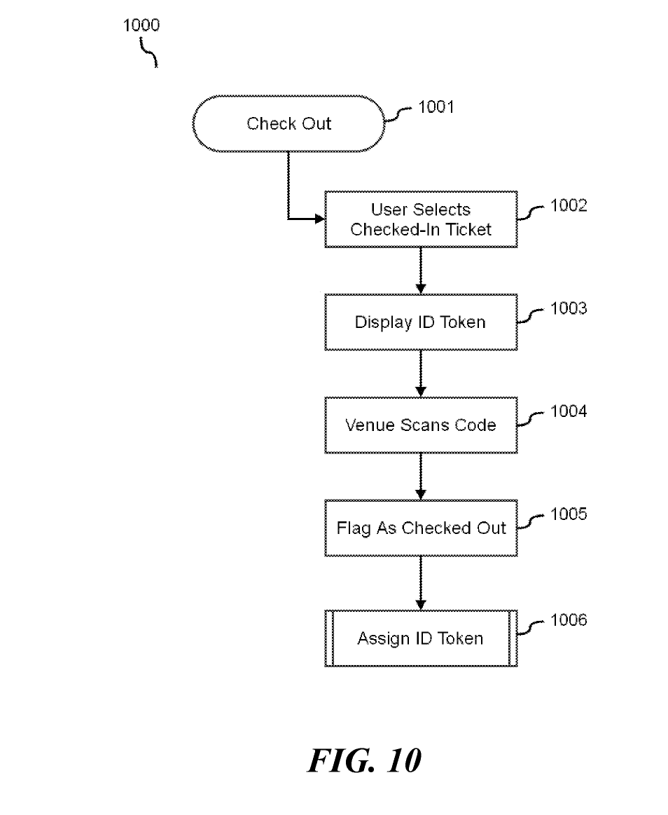

FIG. 10 is a flowchart representing an embodiment of a method for assigning a user's one or more subsequent access rights in accordance with the present disclosure. The method 1000 begins at a first step 1001 when a user request to check out of an event into which the user is currently checked in, such as in accordance with method 900 described above. In an embodiment, the user may request the application to display one or more tickets associated with the user and currently flagged as checked in. In step 1002 the user selects on an application's user interface one or more of the tickets flagged as checked in for a current event. In response and proceeding to step 1003, the application displays or otherwise transmits the one or more identification tokens of the one or more selected tickets for check-out verification by the venue access agent. In step 1004, the venue access agent may verify the one or more identification tokens. In some embodiments, the venue access agent may verify the identification token through a verification device such as a QR code scanner.

In step 1005, the user and one or more tickets presented are flagged as checked out. In embodiments, the user's mobile device may be updated with the one or more tickets' and or user's checked-out status and subsequently notify the user of successful check-out. For example, the mobile device may generate an audio and/or visual notification upon determination of the user's checked-out status, such as playing a chime and/or changing the background or icon color on the mobile device display. The notification may be different from a notification used for notifying the user of successful check-in. In certain embodiments, the mobile device may be updated from the one or more ticket servers by means of a communications network or communications protocol. In alternative embodiments, the mobile device may be updated from the scanner verification device by means of a communications network or communications protocol.

In step 1006, the server may assign a new identification token for the one or more tickets and/or ticket items. Step 1006 may be embodied by or performed in accordance with method 1100 described herein. In certain embodiments, the completion of step 1005 wherein the ticket is flagged as checked out may update or modify the user's access rights for the venue. For example, a venue may allow a user to check back into of the venue during the event's duration and gain subsequent access as embodied in method 900 described above; may disallow a user access to one or more event services such as access to digital content; and may disallow a user access to one or more event networks such as a Wi-Fi network or node network. In certain embodiments, a user's access rights may limit the user from checking in and out of a venue event a certain number of times.

In certain embodiments, venues, users, and the like may selectively prohibit one or more users from assigning access rights in accordance with the method 1000 listed herein, wherein prohibited users will not be able to perform the method 1000.

The method 1000 may be further contemplated in various embodiments of systems and methods without reference to distribution of tickets between a first and second user and without reference to other methods described herein.

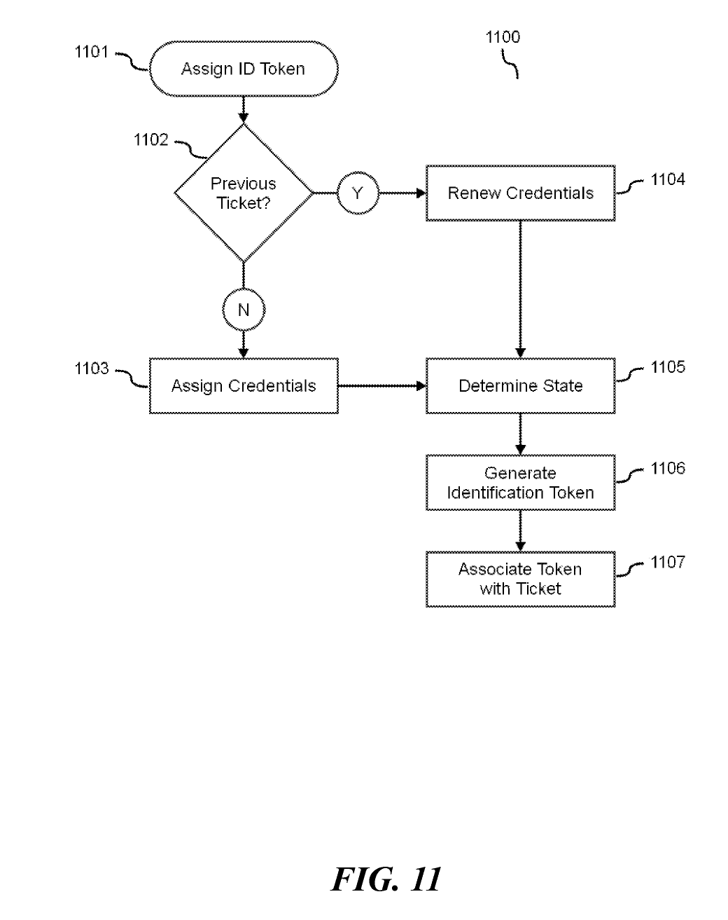

FIG. 11 is a flowchart representing an embodiment of a method for assigning one or more identification tokens to a ticket in accordance with the present disclosure. The method 1100 begins at a first step 1101 when a request for a new identification token for a ticket or ticket item is generated. Requests for new identification tokens may occur when a ticket is created, when an associated user for a ticket changes, when access rights for an associated user are modified, and for a user checking in or checking out of an event. In certain embodiments, requests may be sent to a ticket server which may subsequently generate the identification token in accordance with method 1100. In alternative embodiments, the identification token may be created via an authorized application on the user's mobile device and associated with the ticket server.

In step 1102 and in response to an identification token request for a ticket, the system determines if the ticket has been previously assigned a code. A previously assigned identification token, if any, may be submitted with the ticket request, or alternatively the system may reference a ticket database to determine if the ticket has been associated with an identification token previously. If no identification token has been associated with the ticket, such as with the generation of a new ticket upon primary marketplace purchase, then the system proceeds to step 1103 and assigns user and ticket credentials to the ticket. User and ticket credentials may include the purchasing user's name, event name, event venue, event time, access type, number of permitted individuals, and so forth. In an embodiment, the ticket may be assigned a unique ticket identifier, the identifier stored in the ticket database. If an identification token has been associated with the ticket, then the system proceeds to step 1104 and renews the user and ticket credentials. In an embodiment, the server may query for new credentials associated with the ticket or alternatively be provided with the new credentials with the identification token request. For example, an identification token request may be generated when a primary user sells a ticket to a secondary user; the new credentials would include at least the secondary user's user credentials which would be associated with the ticket while the primary user's user credentials would be disassociated with the ticket.

In step 1105, the system may determine the state of the ticket. The state of the ticket may include the access rights associated with the ticket and whether the ticket is currently flagged as checked in or checked out. In step 1106, the system generates at least one or more new identification tokens in association with the current user and ticket credentials and the state of the ticket. For example, an identification token for a ticket flagged as checked out may result in the generation of a red identification token whereas an identification token for a ticket flagged as checked in may result in the generation of a green identification token. In certain embodiments, additional computer-implemented tokens or verification factors may be generated separately or within the same identification token respectively.

In step 1107, the system associates the new identification token or identification tokens with the ticket. In some embodiments, the system may store the associated identification tokens in the ticket database and update the mobile device application display with the associated identification tokens for the ticket. The method 1100 may be further contemplated in various embodiments of systems and methods without reference to distribution of tickets between a first and second user and without reference to other methods described herein.

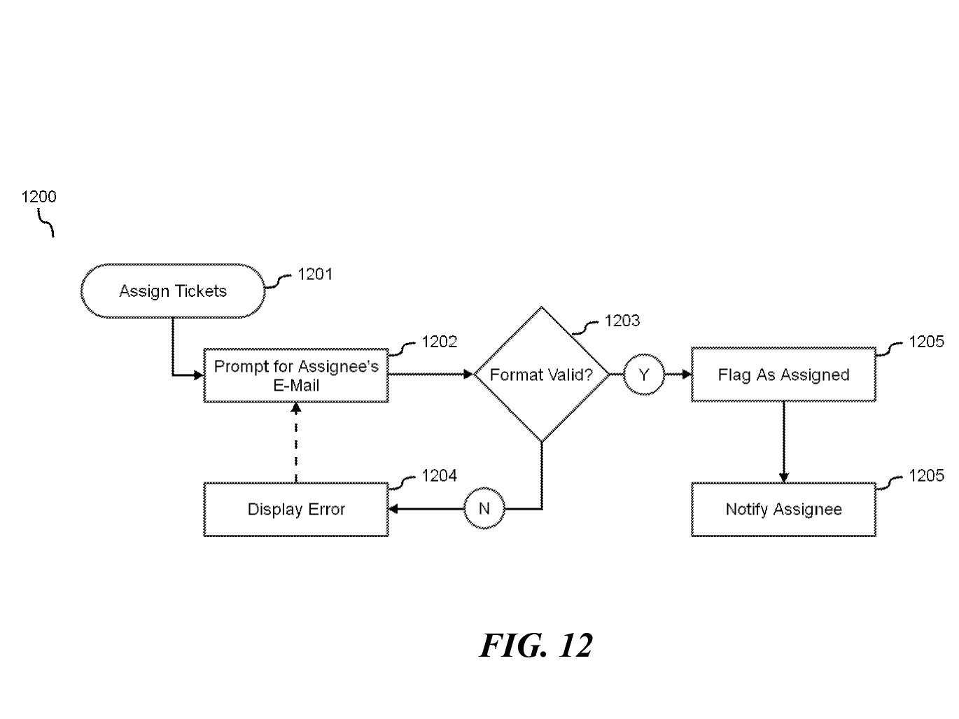

FIG. 12 is a flowchart representing an embodiment of a method for enabling transfer of access rights from a first user to a second user in accordance with the present disclosure. The method 1200 begins at a first step 1201 wherein a first user selects one or more tickets owned by the first user to be assigned to a second user. The system prompts the first user for the second user's e-mail address (step 1202). In certain embodiments, the system may perform alternative methods of identifying the second user such as by prompting for the second user's username or phone number. In step 1203, the system flags the one or more selected tickets as assigned. In certain embodiments, tickets flagged as assigned may be recalled by the first user prior to the second user's acceptance of the assignment, wherein the tickets will be un-flagged as assigned and can be subsequently used by the first user, reassigned to the same second user or other users, or sold on the secondary marketplace.

In step 1204, the system notifies the second user of the assignment. In certain embodiments, the system may prompt the second user whether the second user wishes to accept the assignment such as in accordance with method 1300 described herein. The system may notify the user via the determined communication method as prompted of the first user in step 1202, such that for a second user's e-mail address an e-mail notification may be sent, for a second user's phone number an SMS message or phone call notification may be sent, and the like. In an embodiment, the system may determine whether the second user has an active user account. In said embodiment, if the second user has an active account, a notification may be sent via an application such as described in method 1700 herein, whereas if the second user does not have an active account, a notification may be sent to the user's e-mail and optionally with a request to create a user account such as described in method 500 above. Said embodiment may be performed in accordance with method 1300 listed below.

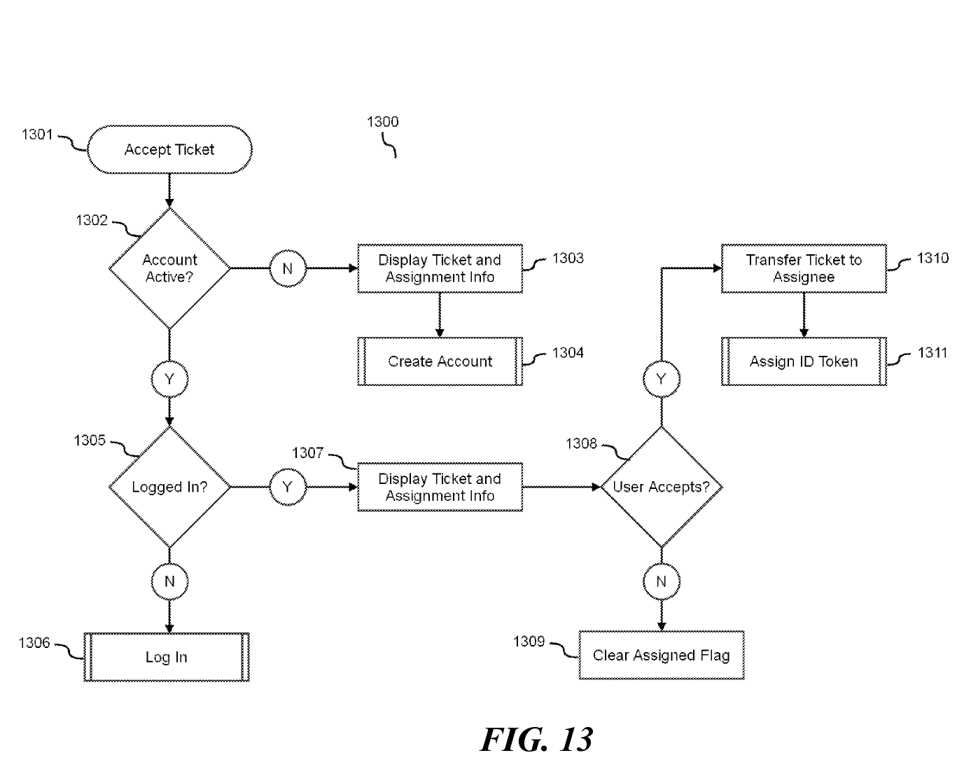

FIG. 13 is a flowchart representing an embodiment of a method for enabling a second user to accept the transfer of access rights from a first user in accordance with the present disclosure. The method 1300 begins at a first step 1301 wherein a second user is prompted to accept a ticket assigned by a first user. The ticket assignment may be performed in accordance with the method 1200 described above. In certain embodiments, a second user may be prompted to accept the ticket assignment by notification via e-mail, SMS message, phone voice message, in-application notification, and the like. In step 1302, the system determines whether the second user has an active user account. If the second user does not have an active account, then the system may display the ticket and assignment information via the notification, such as in the e-mail or via a hyperlink to a web page (step 1303). In step 1304, the system may request the second user to create a user account such as is described in method 500 above.

If the second user does have an active account, then the system will determine if the user is currently logged in (step 1305). If the user is not logged in, then the system may prompt the user to log in (step 1306), such as in accordance with method 400 described above. If the user is logged in, then the system may display the ticket and assignment information via the application and in association with the logged-in account and prompt the second user as to whether the second user accepts or denies the ticket assignment (step 1307).

In step 1308, the second user may accept or reject the ticket assignment by the first user. If the second user rejects the ticket assignment, the system may clear the assignment flag for the assigned ticket (step 1309) and thereby return it for use, reassignment, or sale by the first user. If the second user accepts the ticket assignment, then the system may transfer the assigned ticket to the second user (step 1310). The first user's credentials will be disassociated from the ticket and the second user's credentials will become associated with the ticket; in step 1311, a new identification token may be assigned. Step 1311 may be embodied by or performed in accordance with method 1100 described above.

In certain embodiments, venues, users, and the like may selectively prohibit one or more users from accepting the transfer of access rights in accordance with the method 1300 listed herein, wherein prohibited users will not be able to perform the method 1300.

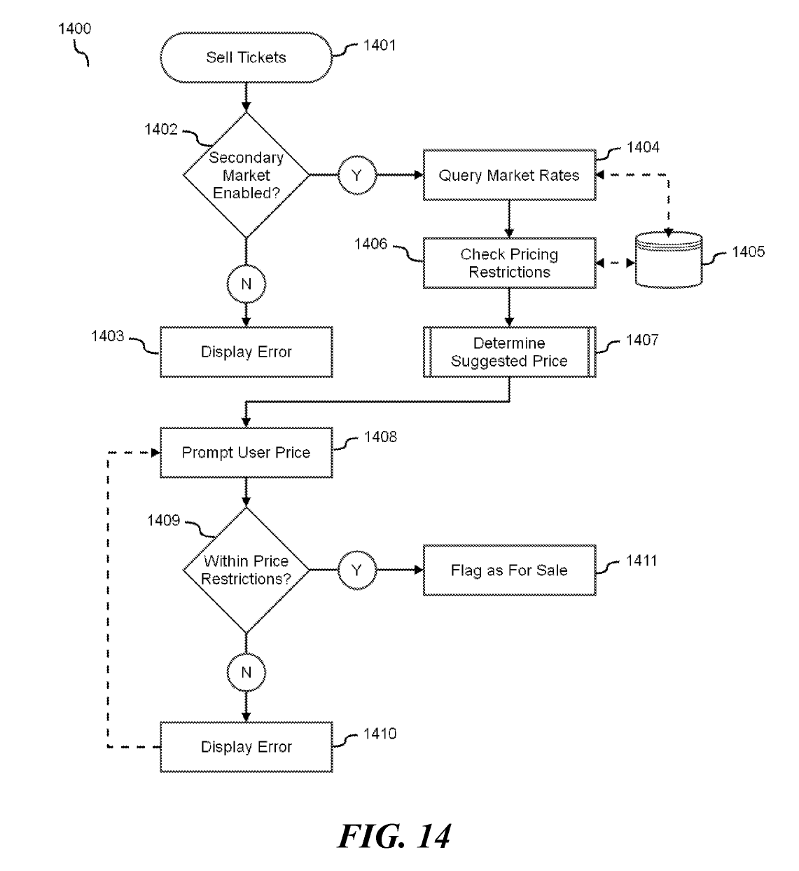

FIG. 14 is a flowchart representing an embodiment of a method for enabling the sale of access rights from a first user to a second user in accordance with the present disclosure. The method 1400 begins at a first step 1401 when a user selects for sale one or more owned tickets associated with an event. In step 1402, the server determines whether the venue for the ticket's associated event has authorized secondary market resale for said tickets. If the venue has not authorized the tickets for resale on the secondary market, then the server may generate an error message and prevent the user from selling the selected tickets (step 1403). If the venue has authorized the tickets for resale on the secondary market, then the server may continue to step 1404 and query a marketplace database 1405 for similar tickets for sale and the asking prices thereof. In certain embodiments, the server may query tickets for sale with same or similar access rights for the same event and same or similar access rights from similar events. In certain embodiments, the server may query tickets that have successfully sold with same or similar access rights for the same event and same or similar access rights from similar events.

In step 1406, the server may query the marketplace database or other database for pricing restrictions such as commission fees, transaction fees, and the like. From the queried prices of similar tickets in the marketplace and the queried pricing restrictions, the server may apply the determined variables to one or more algorithms for determining a suggested ticket price for the user-selected ticket for sale (step 1407). In certain embodiments, the algorithm may take into account different weighted averages of primary marketplace tickets and secondary marketplace tickets as well as different weighted averages based upon the degree of similarity of the tickets based upon similarity of venue, similarity of event, and similarity of access rights. The server may then transmit to the user the suggested price for the one or more tickets selected for sale.

In step 1408, the server may prompt the user for the user's decided price, which may be the same as, similar to, or different from the suggested price. In step 1409, upon receiving the user's decided price, the server may check the user's determined price against one or more price restrictions applicable to the user-selected ticket. Price restrictions may optionally be set by the venue or by the system in association with one or more tickets. For example, a venue may set a floor price below which tickets may not be sold and/or a ceiling price above which tickets may not be sold. In certain embodiments, the system may specify a floor price of the cumulative sum of fees applied to the ticket. If the user's determined price is outside the bounds of the one or more price restrictions, then the server may generate an error message (step 1410) and prohibit the sale of the one or more tickets at the user-specified price. If the user's determined price is within the range of the one or more price restrictions, or if no price restrictions are specified, then the system may flag the ticket for sale (step 1411) and list said ticket on the secondary marketplace for purchase by other users. In certain embodiments, the user may be able to retract the sale and un-flag the ticket for sale.

In certain embodiments, venues, users, and the like may selectively prohibit one or more users from selling access rights in accordance with the method 1400 listed herein, wherein prohibited users will not be able to perform the method 1400.

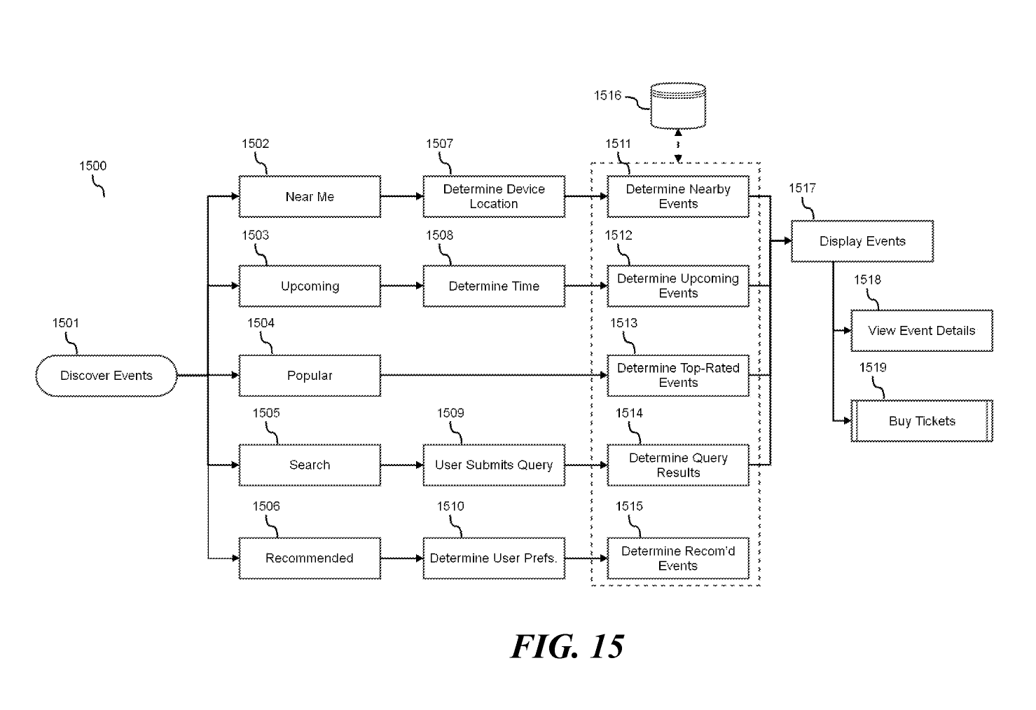

FIG. 15 is a flowchart representing an embodiment of a method for displaying ticketed events for one or more venues via a user interface in accordance with the present disclosure. The method 1500 begins at a first step 1501 when a user requests to view relevant ticketed events. In response to the user's request, the server may provide one or more filtering options for determining said events. In an embodiment, filtering options may include but are not necessarily limited to events near the user (step 1502), upcoming events (step 1503), popular events (step 1504), event search query (step 1505), and recommended events (step 1506). In certain embodiments, other filtering options may be provided.

If the user selects events near the user, the system proceeds to step 1507 and determines the user's current location. In an embodiment, the user's location may be determined by geolocational data such as a mobile device's GPS position, Wi-Fi signal, cell tower triangulation, IP address, or a combination thereof. Alternatively, if a user selected upcoming events, the system proceeds to step 1508 and determines the current time. In an embodiment, the server may determine the time from the user's mobile device. In another embodiment, the server may determine the time from a server clock.

Alternatively, if a user selects a search option, the system proceeds to step 1509 wherein the user may enter and submit a search query. In an embodiment, the user may submit a natural language search. In other embodiments, the user may select from a range of predetermined options such as date, time, event type, price, and the like for returning a plurality of events that meet the user-selected criteria. Alternatively, if a user selects recommended events, the system proceeds to step 1610 wherein the system determines one or more user preferences. In an embodiment, user preferences may be stored in association with the user account. In an embodiment, user preferences may be determined in part or in whole from music stored on the user's mobile device. For example, the server may query all music on a user's mobile device, or the server may determine preferred music from determination of marked favorites, playlists, number of plays, and the like, and generate user preferences in association with said determination(s). In an embodiment, user preferences may be determined in part or in whole from information obtained from one or more user accounts for other applications and in association with the user. For example, the server may determine user preferences from user-created or user-subscribed music channels or application-based listening information on one or more music streaming applications. In a further example, the server may generate user preferences in accordance with musical information determined from either music stored on the phone or music streamed from a music streaming application, or both, based upon: songs, artists, albums, genres, musical metadata, musical composition data, and the like.

From step 1508, upon determining the user's position, the server may determine events that are listed as nearby by querying an event database 1516 for event locations and comparing the event locations to the user's location and selecting events within a specific proximity for display (step 1512). In an embodiment, the server may determine event locations by determining venue locations within a specific proximity based upon venue information such as a GPS location and then listing events for proximate venues. From step 1508, upon determining the current time, the server may determine from the event database 1516 a list of upcoming events (step 1511). In an embodiment, the server may order the determined list of upcoming events in chronological order. In an embodiment, the server may determine only upcoming events within a specific period of time, such as for example, one month. From step 1504, the server may determine from the event database 1516 a list of popular events (step 1513). In an embodiment, the list of popular events may be determined from a plurality of popularity factors including event views by other users, venue size, act popularity, social media trending, paid or unpaid event promotion, rate of ticket sales, percentage of tickets available for sale over total percentage of tickets for the event, and so forth.

From step 1509, the server may determine from the user query and in accordance with one or more search algorithms a list of results from the event database 1516 that meet or substantially meet the search criteria (step 1514). From step 1510, the server may determine from the user preferences a list of recommended events from the event database 1516 that meet or substantially meet the determined user preferences. For example, the server may specify a preferred artist within the user preferences and determine events where that artist or artists similar to that artist are performing.

Upon determination of the appropriate list of events to display, in step 1517 the server displays the events to the user. In certain embodiments, other limiting factors may be considered; for example, a list of upcoming events may be limited both by chronology and by a user's location. In step 1518, a user may optionally select an event from the list of displayed events to view the selected event's details. In step 1519, a user may optionally select an event from the list of displayed events to purchase one or more tickets for the selected event. In certain embodiments, a user may be prohibited from selecting to purchase tickets from a selected event such as if tickets have not been listed for sale by the venue or if tickets are currently sold out from both primary and secondary marketplaces. Step 1519 may be embodied by or performed in accordance with method 1600 described below.

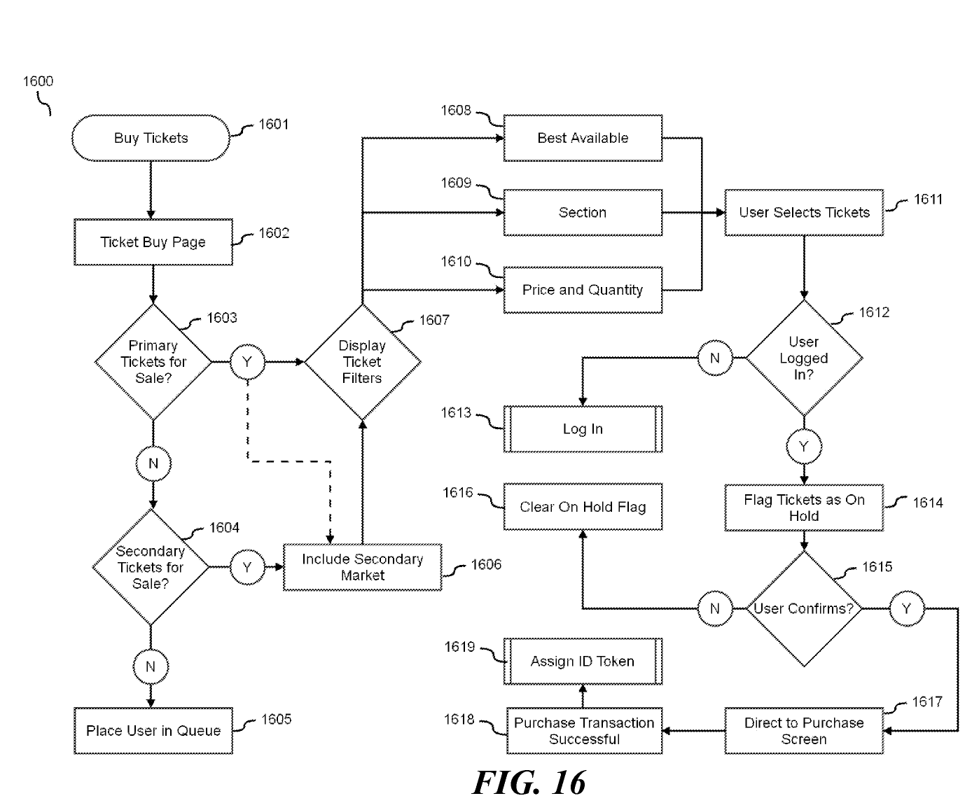

FIG. 16 is a flowchart representing an embodiment a method for enabling the purchase of access rights from a first user, or a venue, or a combination thereof, by a second user in accordance with the present disclosure. The method 1600 begins at a first step 1601 wherein a user requests to buy tickets for a selected event. The user may navigate to a ticket purchase page for a selected event (step 1602). Upon the user's navigation to the ticket purchase page, the server may query one or more databases to determine whether any of the event's primary marketplace tickets are currently on sale (step 1603). If the event does not have primary marketplace tickets available, the server may query the one or more databases to determine whether the event has any secondary marketplace tickets for sale by other users (step 1604). If the event does not have any tickets currently on sale in either the primary or secondary marketplace, then the server may notify the user that no tickets are available and place the user in a ticket queue for notification of tickets for sale in either the primary or secondary marketplace (step 1605). If secondary market tickets are available for sale for an event, then the server may return a list of all or some secondary market tickets for sale for the event (step 1606). In an embodiment, the user may optionally select to include secondary marketplace tickets even if primary marketplace tickets are available.

If either primary or secondary marketplace tickets are available, the system proceeds to step 1607 and displays one or more ticket filters for user selection. A user may select to be presented with a list of best available tickets (step 1608), to be presented with a list of tickets for one or more user-determined sections (step 1609), or to be presented with a list of tickets within a range of one or more user-determined criteria including at least maximum price and quantity (step 1610). In certain embodiments, upon selecting a ticket filter option a user may be presented with sub-filter options. For example, a user may select a minimum and maximum price range and quantity or may select one or more sections. In each respective step, the server determines from the user's filter selection and any user parameters a list of ticket to display to the user with at least the ticket location, type, and price listed for comparison.

In step 1611, the user may select one or more of the displayed tickets for purchase. In an embodiment, a user's selection may be added to a digital shopping cart for later purchase with other tickets or ticket items. The system determines in step 1612 whether the user is currently logged in. If the user is not logged in, then the system may direct the user to log in (step 1613), such as in accordance with method 400 listed herein. If the user is logged in, then the system may flag the one or more selected tickets as on hold, thereby preventing another user from also selecting said tickets for purchase (step 1614). In an embodiment, the tickets may be flagged as on hold for a specific duration of time, the duration sufficient to allow a user to complete a purchase transaction for said tickets, and after which the ticket hold flags may expire if not purchased within the time limit.

In step 1615, the user may confirm whether or not to purchase the selected tickets. If the user chooses not to purchase the selected tickets, then the tickets are un-flagged as on hold and returned to the marketplace for purchase by users (step 1616). If the user chooses to purchase the tickets, then the user may be directed to a purchase screen wherein the user may select or enter payment verification options (step 1617). In an embodiment, the purchase screen may contain preconfigured payment verification information such as, for example, credit card numbers, credit card expiration dates, credit card CVV codes, billing addresses, and the like. In a further embodiment, the user may optionally select one of a preconfigured payment verification option by touching or swiping a preconfigured payment verification option on a mobile device touchscreen.

Upon user confirmation of the payment verification option, the payment may be submitted for processing to an associated payment processor for the payment verification method. If the payment processor approves the transaction, then the purchase transaction may be deemed successful (step 1618). The application may notify the user that the payment was successful and that the tickets have been purchased. For said purchased tickets, the server may assign one or more identification tokens in association with the user (step 1619). Step 1619 may be performed by or in accordance with the method 1100 listed herein.

In certain embodiments, venues, users, and the like may selectively prohibit one or more users from purchasing access rights in accordance with the method 1600 listed herein, wherein prohibited users will not be able to perform the method 1600.

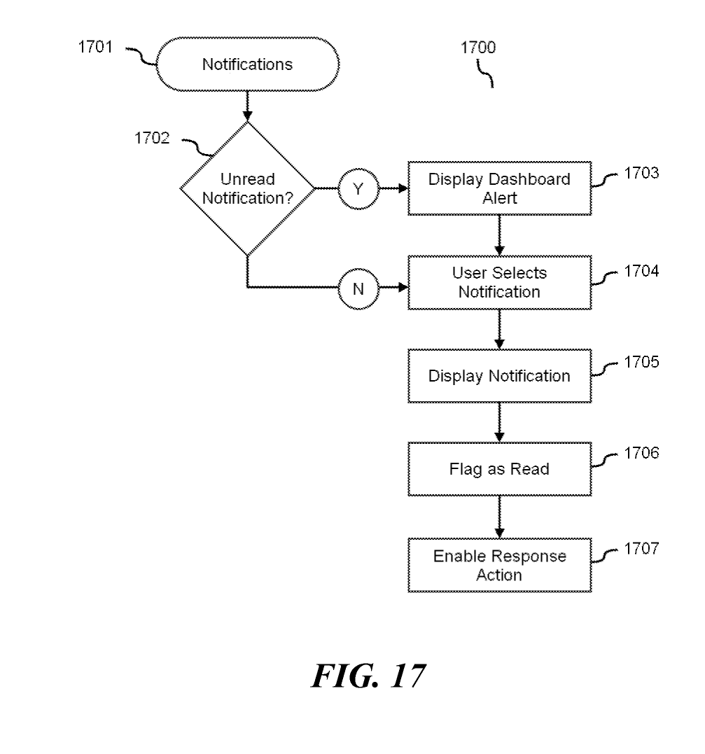

FIG. 17 is a flowchart representing an embodiment of a method for displaying one or more notifications to a user via a user interface in accordance with the present disclosure. The method 1700 begins at a first step 1701 when a user accesses an application's notification display. Access to the notification display may occur when a user selects a notification; when a user receives a notification and is viewing the application in a notification-enabled page; or when a user does not have the application open but has enabled permissions for notifications to be delivered through another protocol such as push notification, e-mail, and the like. In step 1702, the application determines whether the user has an unread notification. If the user has an unread notification, then the application may display a dashboard alert on the user dashboard (1703). In certain embodiments, notification alerts may appear as an icon, a brief description of the notification message, an audio sound, or similar effects. In an embodiment, a dashboard alert may also include a non-application notification such as a push notification for a mobile device.

Notifications may include, for example: notice of a pending ticket assignment, notice of a successful ticket sale, notice of a successful ticket purchase, notice of an upcoming event, notice of a nearby event, notice of a popular event, notice of an event for a specified venue, notice of an event for a specified act, notice that tickets for an event are on sale, notice that tickets for an event are almost sold out, et cetera.

In step 1704, a user may select to view a notification. In an embodiment, if no unread notification exists as determined in step 1702, then the user's selection of the notification option may generate a list of one or more recent notifications that the user has read from which a user can select a specific notification. In an embodiment, if a dashboard alert exists as specified in step 1703, then the application may display one or more of the unread notifications for user selection. In an embodiment, if the user selects the notification for which a dashboard alert has been displayed, then the application may determine that the user has selected to view the most recent notification.

Upon a user's selection of the notification to view as per step 1704, the application may continue to step 1705 and display the notification details. Once the notification details have been displayed, the application may flag the notification as read and clear associated dashboard alerts (1706). For certain notifications, the application may enable a subsequent user response action (step 1707). User response actions may include options to dismiss or delete the notification. In certain embodiments, response actions may be included within the notification details. In certain embodiments, response actions may be contextually sensitive to the type of notification displayed to the user. For example, a notification that tickets are on sale may include an option to buy tickets; a notification of an upcoming event may include an option to view event details; and a notification of a pending ticket transfer to the user may include options to accept or reject the transferred ticket.

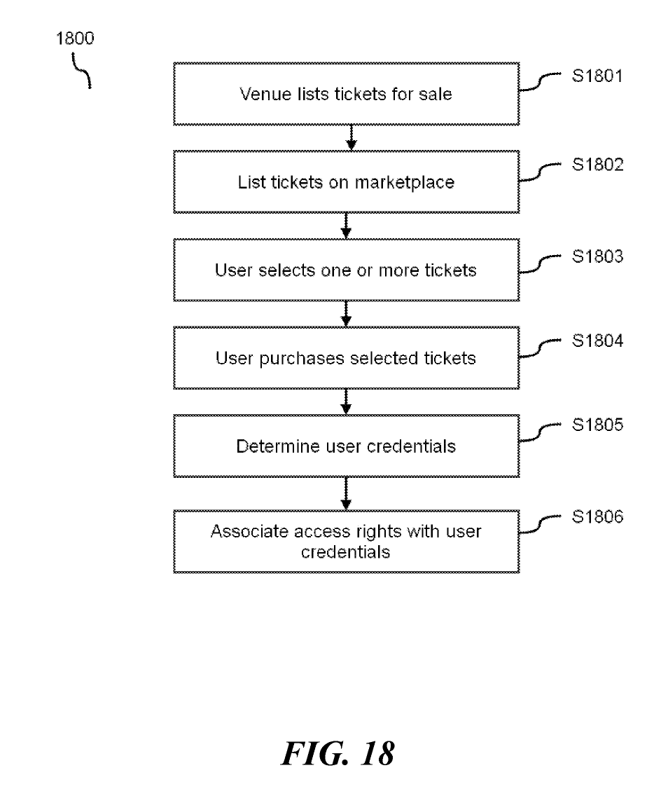

FIG. 18 is a flowchart representing an embodiment of a method for enabling a primary distribution of one or more access rights to a venue in accordance with the present disclosure. The method 1800 begins at a first step S1801 when a venue lists tickets, which for intents and purposes of FIG. 18 may be one or more bundled access rights for one or more events, for sale. Tickets may be for access rights to specific seats, bounded areas such as general admission floor or backstage, benefits such as services or raffles, and the like. The venue submits the ticket information to a server, which stores the information on a database.

In step S1802, the server lists the tickets that the venue has listed for sale on a marketplace. In certain embodiments, the server may list the tickets on a primary marketplace associated with the sale of tickets directly from venues. In other embodiments, the server may list the tickets on a marketplace featuring both primary and secondary tickets associated with tickets sold directly from venues and tickets sold from other users, respectively. The marketplace may be accessible via a communications network, the ticket information thereupon capable of being displayed via a user interface such as a website or mobile application.

In step S1803, a user connected to the server may select one or more of the listed tickets. In an embodiment, the user may be able to select one or more tickets from the marketplace via a user interface of a mobile application. The selection may allow the user to access more information about the ticket. In certain embodiments, user selection may cause the server to place the selected tickets on hold for a specific duration of time, the duration in certain embodiments sufficient to allow a user to complete a purchase transaction for said tickets, such that no other user can purchase said tickets for the duration that the tickets are on hold.

The method continues in step S1804 when a user purchases the selected tickets. The purchase may be made through a mobile application and via an online transaction such that the purchase request and payment information are transmitted to the server and subsequently verified, thereby transmitting funds from the user to the venue and/or server host.

When a purchase has been completed, the server determines the user credentials (S1805). User credentials may be associated with a user account stored on the server in an associated database. For example, a user may have a user account associated with the phone number of a mobile device used to select and purchase the tickets, the user account information determinable from the server based upon a unique session ID for a purchase transaction. In alternative embodiments, user credentials may be associated with unique non-account information such as a credit card number used to purchase the tickets or other payment verification identifiers.

In step S1806, the server associates the access rights of the purchased ticket with the determined user credentials and stores said association in a database. In certain embodiments, the server may generate at least an identification token based upon the associated access rights and user credentials. The identification token may be generated according to the method 2000 described below. The identification token may be displayed on the user's mobile device to allow a venue to visually determine that a user has access rights to the venue for an event. In certain embodiments, the server may generate at least a fraud prevention token based upon the associated rights and user credentials. The fraud prevention token may be displayed on or otherwise transmitted via the user's mobile device to a verification device to allow a venue to automatically determine that a user is verified to exercise said access rights to the venue for an event. For example, a fraud prevention token may include an image, a video, a QR code, a passkey, a password, an encrypted string, or any machine-readable token specifically configured to the user credentials in relation to the access rights purchased in association with the user credentials and capable of display on or transmission via a user's mobile device.

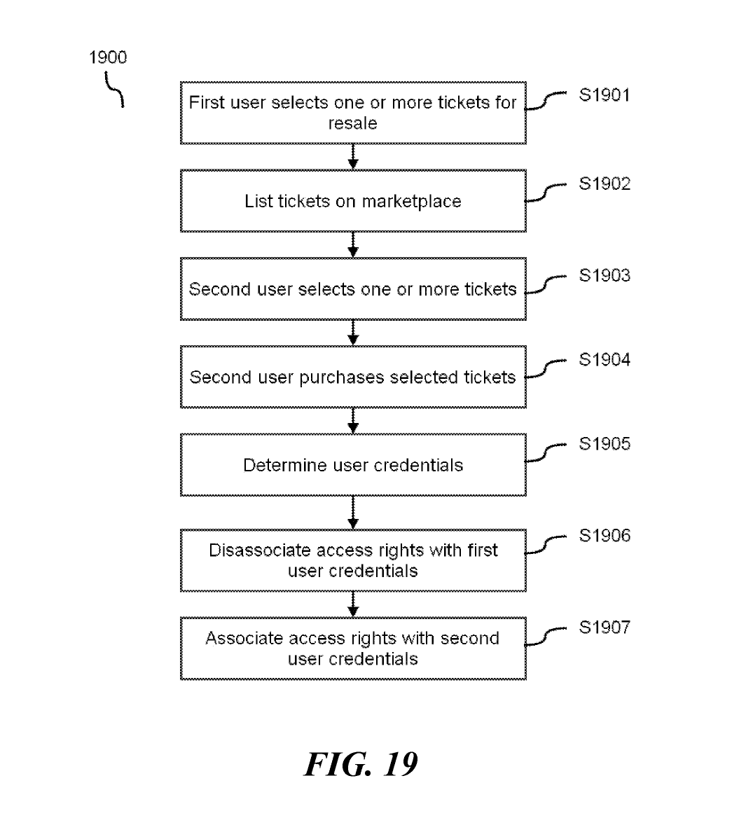

FIG. 19 is a flowchart representing an embodiment of a method for enabling a secondary distribution of one or more access rights to a venue in accordance with the present disclosure. The method 1900 begins at a first step S1901 when a first user selects one or more tickets for sale, the access rights for the one or more tickets associated with the first user. Access rights and/or tickets may be associated with the first user upon a previous primary market purchase such as that described in method 1800 or a previous secondary market distribution as described in this method 1900. The user may select one or more of a plurality of tickets for sale. In certain embodiments, a user may be prohibited from selecting certain tickets for sale if the venue has placed restrictions on the tickets or underlying access rights prohibiting resale on the secondary market. In certain embodiments, the user may select which tickets to sell via a mobile application and then transmit a request to sell said tickets to a server which may verify the request for sale.

In step S1902, the server lists the user-selected tickets for sale on a marketplace. In certain embodiments, the server may list the user-selected tickets on a secondary marketplace associated with the sale of tickets from other users subsequent to the sale of tickets directly from venues. In other embodiments, the server may list the tickets on a marketplace featuring both the primary and secondary tickets associated with tickets sold directly from venues and tickets sold from other users, respectively. The marketplace may be accessible via a communications network, the ticket information thereupon capable of being displayed via a user interface such as a website or mobile application.

In step S1903, a second user connected to the server may select one or more of the listed tickets for sale from the first user. In an embodiment, the second user may be able to select one or more tickets from the marketplace via a user interface of a mobile application. The selection may allow the second user to access more information about the ticket. In certain embodiments, user selection may cause the server to place the selected tickets on hold for a specific duration of time, the duration sufficient to allow the second user to complete a purchase transaction for said tickets on hold for a specific duration of time, the duration sufficient to allow the second user to complete a purchase transaction for said tickets for the duration that the tickets are on hold. In certain embodiments, the second user may be able to select the one or more tickets for resale by the first user in conjunction with other tickets offered on either primary or secondary markets.

In step S1904, the second user purchases the selected tickets. The purchase may be made through a mobile application and via an online transaction such that the purchase request and payment information are transmitted to the server and subsequently verified, thereby transmitting funds from the second user to the first user and/or server host. In certain embodiments, a portion of the funds may be allocated to the venue, artist, promoter, event organizer, and/or similar parties. In certain embodiments, the portion of funds allocated may be calculated as a percentage of the purchase price. In certain embodiments, the portion of funds allocated may be calculated as a percentage of the spread between the purchase price and the initial primary market price of the ticket. In certain embodiments, the portion of funds may be a predetermined flat fee.

When a purchase has been completed, the server determines the second user's credentials (S1905). The second user's credentials may be associated with a user account, unique from other user accounts including the user account of the first user, and stored on the server in an associated database. For example, a second user may have a user account associated with a phone number of a mobile device used to select and purchase the tickets, the user account information determinable from the server based upon a unique session ID for a purchase transaction. In alternative embodiments, user credentials may be associated with unique non-account information such as the second user's credit card number used to purchase the tickets or other payment verification identifiers.

In step S1906, the server disassociates the access rights of the purchased ticket from the first user's user credentials, revoking any associated ownership or access rights from the first user. In step S1907, the server associates the access rights of the purchased ticket with the determined user credentials of the second user and stores said association in a database. In certain embodiments, the server may generate at least an identification token based upon the associated access rights and user credentials of the second user. The identification token may be generated according to the method 2000 described below. The identification token may be displayed on the second user's mobile device to allow the venue to visually determine that the second user has access rights to the venue for an event. In certain embodiments, the server may generate at least a fraud prevention token based upon the associated rights and second user's user credentials. The fraud prevention token may be displayed on or otherwise transmitted via the second user's mobile device to a verification device to allow a venue to automatically determine that the second user is verified to exercise said access rights to the venue for an event. For example, a fraud prevention token may include an image, a video, a QR code, a passkey, a password, an encrypted string, or any machine-readable token specifically configured to the user credentials in relation to the access rights purchased in association with the user credentials and capable of display on or transmission via a user's mobile device. Steps S1906 and S1907 may be performed in various embodiments in the listed order, in reverse order to the listed order, or simultaneously to one another.

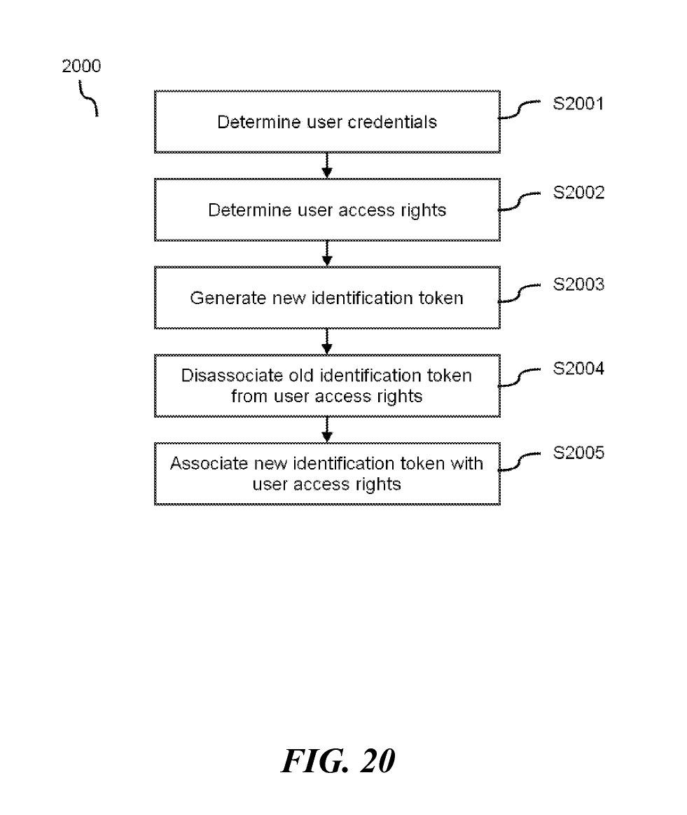

FIG. 20 is a flowchart representing an embodiment of a method for assigning one or more identification tokens to one or more users in accordance with the present disclosure. The method 2000 begins at step S2001 where a server determines for a ticket transaction (e.g. purchase, sale, or transfer) the recipient user's user credentials. The server also determines in step S2002, which may be performed prior or simultaneous to step S2001, the access rights associated with the ticket and/or the user credentials. Once the server has determined the user credentials and user access rights, the server proceeds to step S2003 and generates a new identification token unique to the user credentials and one or more user access rights. In certain embodiments, an identification token may be generated along with, contain, or function as a fraud prevention token. For example, an identification token may be a graphical visualization of a ticket as rendered upon a mobile device. In said example, the graphical visualization of the ticket may include one or more user identifiers such as name, user name, and photograph; one or more user access rights such as ticket level, number of guests, and number of entries; and one or more security elements such as scannable QR codes or barcodes, graphics, video, and passcodes.

In step S2004, the server disassociates any old identification tokens, if any, that are associated from the user access rights. For example, where a first user transfer or sells tickets to a second user as per method 1900, the first user's identification token generated upon purchase of the tickets and assignment of said tickets to the first user will be disassociated from the tickets. In step S2005, the server associates the new identification token with the user access rights. In alternative embodiments, step S2005 may be performed prior or simultaneous to S2004 so long as the new identification token generated for the current user remains associated with the access rights for at least the current iteration of the method 2000. In certain embodiments, the server may retain a history of old, disassociated identification tokens for a given user access right or bundle of user access rights.

Where the various figures may describe embodiments sharing various common elements and features with other embodiments, similar elements and features are given the same reference numerals and redundant description thereof may be omitted below.

The previous detailed description has been provided for the purposes of illustration and description. Thus, although there have been described particular embodiments of a new and useful invention, it is not intended that such references be construed as limitations upon the scope of this invention except as set forth in the following claims.

1. A hosting system for distributing one or more access licenses, comprising:
one or more servers in association with one or more processors, wherein the one or more servers are communicatively linked to a communications network; and
a computer readable medium with one or more software instructions residing thereon, the software instructions executable by the one or more processors to direct the performance of operations comprising:
enabling a first user to purchase one or more of a plurality of access licenses associated with a venue event, each respective access license authorizing access for an individual with respect to the venue event;
distributing the one or more access licenses to the first user, and assigning at least a first identification token to the first user;
enabling a second user to obtain one or more of the access licenses distributed to the first user;
distributing to the second user the one or more access licenses obtained from the first user, and assigning a second identification token to the second user, wherein the second identification token is different from the first identification token and at least a third identification token retained by the first user in association with one or more access licenses that were not distributed to the second user;
storing information associated with each of the second and third identification tokens in a data repository, and invalidating the first identification token;
receiving identification token information from a verification device associated with an attempted access to the venue event;
comparing the received identification token information with information stored in the data repository to determine if received identification token information is associated with an access license for the venue event;
generating a validation determination that an identification token corresponding to the received identification token information is either a valid identification token or an invalid identification token; and
transmitting the validation determination to one or more of a first user device, a second user device, or the verification device.

2. The system of claim 1, wherein the software instructions are further executable by the processor to direct the performance of operations comprising:
distributing to a subsequent user one or more access rights from either a first user, second user or another subsequent user;
assigning a fourth identification token to the subsequent user in association with the one or more access rights distributed to the subsequent user, wherein the fourth identification token is different from the first, second and third identification tokens and at least a fifth identification token retained in association with any one or more access licenses that were not distributed to the subsequent user; and
storing information associated with each of the fourth and fifth identification tokens in a data repository.

3. The system of claim 2, wherein the software instructions are further executable by the processor to direct the performance of operations comprising:
enabling any of a respective first user, second user or subsequent user to generate a profile including user credentials associated with the respective user, wherein the user credentials includes the identity of the respective user; and
associating the user credentials of one or more users associated with one or more valid identification tokens for an event; and
generating an event profile including the identity of each respective user having one or more valid identification tokens for said event.

4. The system of claim 3, wherein the software instructions are further executable by the processor to direct the performance of operations comprising:
enabling any first user, second user, or subsequent user to include payment information in their profile; and
verifying payment information of the respective user before distributing one or more access licenses thereto.

5. The system of claim 2, wherein the software instructions are further executable by the processor to direct the performance of operations comprising:
enabling any of a respective first user, second user, or subsequent user to input criteria to search for one or more access licenses available for a venue;
generating a list of available access licenses corresponding to the input criteria provided by the user, wherein the list of available access licenses may include access licenses available from the venue or from another first user, second user, or subsequent user;
distributing to the respective user one or more access licenses from the venue and one or more access license from another user; and
assigning one or more identification tokens upon distributing said one or more access licenses.

6. The system of claim 1, wherein the verification device comprises one or more nodes located at one or more designated areas at a venue and communicatively linked to the communications network, and wherein the software instructions on the computer readable medium are further executable by the processor to direct the performance of operations comprising:
dynamically generating an ordered list of attendees based on a distance determinable from one or more nodes to the respective user devices associated with one or more valid identification token.

7. (canceled)

8. The system of claim 1, wherein the identification token further comprises a fraud prevention token.

9. The system of claim 1, further comprising one or more nodes located at one or more designated areas at a venue, wherein the software instructions are further executable by the processor to direct the performance of operations comprising:
dynamically generating at least one notification; and
transmitting the at least one notification to the respective one or more user devices when said one or more user devices associated with one or more valid identification tokens comes within range of the one or more nodes.

10-20. (canceled)

21. The system of claim 1, further comprising the steps of:
enabling any user having purchased or obtained one or more access rights to identify any of the purchased or obtained one or more access rights that are available for transfer; and
enabling the user to set a fee for the transfer of one or more access rights to any other user.

22. The system of claim 21, further comprising the step of:
levying a fee each time one or more access rights are distributed to any respective user.

23. The system of claim 1, wherein the operation of transmitting the validation determination to one or more of a first user device, a second user device, or the verification device further comprises:
providing a visual cue that one or more identification tokens presented to the verification device are valid or invalid.

24. A method of validating access to a venue event for each of a plurality of users having purchased or obtained access licenses, the method comprising:
enabling a first user via a user interface to purchase one or more of a plurality of access licenses associated with a venue event, each respective access license authorizing access by an individual to the venue event;
associating the one or more access licenses with the first user in a data repository;
assigning at least a first identification token to the first user, the identification token displayable on a mobile device associated with the first user;
enabling a second user to obtain one or more of the access licenses associated with the first user;
associating the one or more obtained access licenses with the second user in the data repository;
assigning a second identification token to the second user, the identification token displayable on a mobile device associated with the second user, wherein the second identification token is different from the first identification token and at least a third identification token retained by the first user in association with any one or more access licenses that are still associated with the first user;
storing information associated with each of the second and third identification tokens in the data repository, and invalidating the first identification token; and
upon presentation of an identification token to a verification device associated with an attempted access to the venue event, determining if the presented identification token is valid or invalid.

25. The method of claim 24, wherein the step of determining if the identification token is valid or invalid comprises:
receiving identification token information from the verification device;
comparing the received identification token information with information stored in the data repository to determine if the identification token is associated with an identification token that is valid;
generating a validation determination that the identification token is either a valid identification token or an invalid identification token; and
transmitting the validation determination to one or more of a first user device, a second user device, or the verification device.

26. The method of claim 24, further comprising:
associating with a subsequent user one or more access rights obtained from either a first user, second user or another subsequent user;
assigning a fourth identification token to the subsequent user in association with the one or more access rights obtained by the subsequent user, wherein the fourth identification token is different from the first, second and third identification tokens and at least a fifth identification token retained in association with any one or more access licenses that were not obtained by the subsequent user; and
storing information associated with each of the fourth and fifth identification tokens in the data repository.

27. The method of claim 26, further comprising:
enabling any of a respective first user, second user or subsequent user to generate a profile including user credentials associated with the respective user, wherein the user credentials includes the identity of the respective user; and
associating the user credentials of one or more users associated with one or more valid identification tokens for an event; and
generating an event profile including the identity of each respective user having one or more valid identification tokens for said event.

28. The method of claim 27, further comprising:
enabling any first user, second user, or subsequent user to include payment information in their profile; and
verifying payment information of the respective user before associating one or more access licenses therewith.

29. The method of claim 26, further comprising:
enabling any first user, second user, or subsequent user to input criteria to search for one or more access licenses available for a venue;
generating a list of available access licenses corresponding to the input criteria provided by the user, wherein the list of available access licenses may include access licenses available from the venue or from another first user, second user, or subsequent user;
distributing to the respective user one or more access licenses obtained from the venue and one or more access licenses obtained from another user; and
assigning one or more identification tokens upon distributing said one or more access licenses.

30. The method of claim 24, wherein the verification device comprises one or more nodes located at one or more designated areas at a venue and communicatively linked to the communications network, and wherein the method further comprises:
dynamically generating an ordered list of attendees based on a distance determinable from one or more nodes to the respective user devices associated with one or more valid identification token.

31. A system for distributing access licenses to events associated with a venue, the system comprising:
one or more scanner verification devices disposed about the venue and linked to a communications network; and
a hosted server linked to the one or more verification devices via the communications network, the server configured to
enable a first user to purchase one or more of a plurality of access licenses associated with a particular venue event, each respective access license authorizing access by an individual to the venue event;
assigning a first unique identification token corresponding to the purchased access licenses to the first user;
enabling a second user to obtain one or more of the access licenses distributed to the first user;
assigning a second unique identification token corresponding to the obtained access licenses to the second user;
assigning a third unique identification token to the first user in association with any one or more access licenses that were not distributed to the second user;
storing information associated with each of the second and third identification tokens in a data repository associated with the hosted server, and invalidating the first identification token;
upon presentation of an identification token for scanning by one of the verification devices, receiving identification token information from said verification device;
comparing the received identification token information with information stored in the data repository to determine if received identification token information is associated with an access license for the venue event;
generating a validation determination that an identification token corresponding to the received identification token information is either a valid identification token or an invalid identification token; and
transmitting the validation determination to one or more of a first user device, a second user device, or the verification device that scanned the token.

32. The system of claim 31, further comprising one or more nodes located at one or more designated areas associated with the venue, wherein the server is further configured to
identify access rights associated with a user device geographically proximate to one or more nodes;
dynamically generate at least one geo-locational or service-oriented access notification; and
transmitting the at least one notification to the user device.
